(19) United States
(12) Patent Application Publication
(10) Pub. No.: US 2015/0338524 A1
(43) Pub. Date: Nov. 26, 2015

(54) METHODS AND DEVICES FOR IMPROVED POSITION DETERMINATION

(71) Applicant: Ariel-University Research and Development Company Ltd., Ariel (IL)

(72) Inventors: Boaz BEN MOSHE, Herzlia (IL); Harel LEVI, Tel-Aviv (IL); Roy YOZEVITCH, Nofim (IL)

(21) Appl. No.: 14/411,394

(22) PCT Filed: Jun. 25, 2013
(86) PCT No.: PCT/IB2013/055224

§ 371 Date: Dec. 25, 2014

Related U.S. Application Data
(60) Provisional application No. 61/750,903, filed on Jan. 10, 2013.
(60) Provisional application No. 61/664,183, filed on Jun. 26, 2012.

(51) Int. Cl. G01S 19/42; G01S 19/52; G01S 19/50

(52) U.S. Cl. CPC G01S 19/421; G01S 19/50; G01S 19/52

(57) ABSTRACT

Disclosed are methods and devices that in some embodiments are useful in improving a position determination of a receiver of a global navigation satellite system.

### RELATED APPLICATION

The present application gains priority from U.S. Provisional Patent Application 61/664,183 filed 26 Jun. 2012 and from U.S. Provisional Patent Application 61/750,903 filed 10 Jan. 2013, both which are incorporated herein by reference as if fully set forth herein.

The present application is related to PCT/IB2011/055899 having an International Filing Date of 22 Dec. 2011 published on 28 Jun. 2012 as WO2012/085876 of the Applicant that gains priority from U.S. Provisional Patent Application 61/426,541 filed 23 Dec. 2010.

### FIELD AND BACKGROUND OF THE INVENTION

The invention, in some embodiments, relates to the field of global navigation satellite systems, and more particularly to methods and devices for improving a position determined using a receiver of a global navigation satellite systems.

The invention, in some embodiments, relates to the field of vehicle navigation, and more particularly to methods and devices for improving position determination and lane detection of a vehicle using global navigation satellite systems. Detection of the specific lane in which a vehicle is driving in real-time may be useful for various applications such as autonomous driving, Automated Vehicle Location (AVL) systems, and safety awareness and navigation software. Additionally, GNSS systems may require accurate lane detection in order to provide sufficiently accurate driving instructions.

Global Navigation Satellite Systems (GNSS) typically allow suitable GNSS receivers to autonomously determine an own location (longitude, latitude, and altitude) on the globe using ephemeris data and time signals transmitted from one or more GNSS satellites.

A GNSS receiver receives signals from multiple GNSS satellites that include the precise coordinates of the satellites contained in the ephemeris data and the time stamps received from each satellite, and calculates a pseudorange from each satellite, corresponding to the distance from the receiver is expected be from the satellite. Using at least four pseudoranges and the location of the respective satellites, a GNSS receiver determines an own location by trilateration. The location is generally provided to a user as a presumed location area, for example a position circle having a center point and a radius which magnitude is related to an estimated error.

Disregarding topography and terrestrial objects on the Earth's surface, most global navigation satellite systems, such as GPS (US), GLONASS (Russia) and Galileo (European Union), have satellite coverage that ensures that a receiver on Earth has simultaneous lines of sight (LOS) to at least four satellites, resulting in typical positioning accuracy of 3-5 meters.

When the line of sight to a number of satellites is blocked (for example, by buildings found in an urban area), the accuracy of the position determination may decrease so that the presumed location area provided as a location of a GNSS receiver may be larger (e.g., a large-radius position circle). Additionally, some signals received in cluttered areas, for example, in urban areas, may be received after having been reflected one or more times from an object. Blocked lines of sight and signal reflections typically lead to estimated errors in position calculation of a few tens of meters, and in some instances even up to hundreds of meters. In some such cases the GNSS receiver is not able to calculate a position at all.

Several methods for determining whether a GNSS satellite has a line of sight (an “LOS satellite”) or does not have a line of sight (an “NLOS satellite”) to a GNSS receiver, are known, see for example, U.S. Pat. No. 7,577,445 and U.S. Patent Application Publication No. 2005/0124368.

In addition to methods for determining whether or not a satellite is in line of sight to a receiver, several methods for improving the accuracy of a position calculation of a GNSS receiver are known, such as Map Matching, dead-reckoning, and integrating data from other sensors or transmissions received from non-GNSS transmitters, for example Wi-Fi access points.

The typical GNSS position accuracy of approximately 3-5 meters is insufficient for robust lane detection (identifying which lane of a multi-lane road a vehicle is traveling). Even though navigation software uses other methods to overcome this position inaccuracy, navigation software often fails to navigate correctly when lane detection is critical, such as in branched interchanges or when the lanes are close to one another, possibly leading to different destinations.

Some methods for improving GNSS accuracy in urban canyons using the identification of satellites as LOS or NLOS satellites have been suggested, see for example the Applicant's PCT Application Publication No. WO2012/085876.

### SUMMARY OF THE INVENTION

Some embodiments of the invention relate to methods and devices for determining a position of an object using a global navigation satellite system.

According to an aspect of some embodiments of the invention there is provided a method for determining the position of a GNSS receiver, comprising:
a) from a GNSS receiver, at a monitoring rate, monitoring at least one GNSS satellite that is located above the horizon with respect to the GNSS receiver to identify a transition event where the GNSS receiver changes from:
   i. LOS to NLOS—having an unobstructed line of sight to at least one specific satellite of the at least one GNSS satellite to not having an unobstructed line of sight to the at least one specific satellite; or
   ii. NLOS to LOS—not having an unobstructed line of sight to at least one specific satellite of the at least one GNSS satellite to having an unobstructed line of sight to the at least one specific satellite;
b) if a transition event is identified, identifying a portion of a presumed location area of the GNSS receiver that corresponds to a border of a shadow cast by an object that accounts for the transition event.

In some embodiments, the monitoring rate is at least as frequent as once per second. In some embodiments, the monitoring rate is at least as frequent as five times per second.

In some embodiments, the transition event is identified by a change in signal intensity received by the GNSS receiver from a satellite. In some embodiments, the transition event where the GNSS receiver changes from (i) LOS to NLOS is identified by a reduction of not less than 5 dB in the signal intensity received from that satellite, and in some embodiments, a reduction of not less than 8 dB. In some embodiments, the transition event where the GNSS receiver changes from (ii) NLOS to LOS is identified by an increase of not less than 5 dB in the signal intensity received from that satellite, and in some embodiments, an increase of not less than 8 dB. In some embodiments, a transition event, and particularly a LOS to NLOS transition event, is identified by a Rapid Signal ATtenuation (RSAT) of the signal intensity received from that satellite.

In some embodiments, the transition event is identified by a change in direction of Doppler shift of a signal received by the GNSS receiver from at least one of the at least one satellite that is located above the horizon with respect to the GNSS receiver.

In some embodiments, the border is determined with reference to a three-dimensional representation of the presumed location area.

In some embodiments, the method also includes computing the presumed location area of the GNSS receiver at a presumed area computing rate. In some such embodiments, the method also includes displaying the presumed location area at a display rate, for example overlaid over a two dimensional map including the presumed location area. In some embodiments, the method also includes computing a motion vector of the GNSS receiver.

In some embodiments, the GNSS receiver comprises a device including a display screen, a GNSS signal receiving unit, and a software component. In some such embodiments, the GNSS receiver comprises a modified smartphone.

In some embodiments, the GNSS receiver is functionally-associated with (e.g., mounted upon or within) a vehicle, in some embodiments a terrestrial vehicle (e.g., automobile, truck,), a marine vehicle (e.g., boat or ship) or an aerial vehicle (e.g., fixed-wing aircraft, rotary-wing aircraft). In some embodiments, the GNSS receiver is functionally-associate with (e.g., mounted upon or within) an unmanned vehicle. In some such embodiments, the unmanned vehicle comprises at least one of a self-driving automobile and an Unmanned Aerial Vehicle (UAV).

In some embodiments, the monitoring also includes assigning a timestamp to the transition event, and the identifying of the portion of the presumed location area of the GNSS receiver comprises identifying the border only if the timestamp assigned to the transition event is not older than a predetermined threshold duration.

In some embodiments, the identifying of the portion of the presumed location area of the GNSS receiver comprises identifying the portion of the presumed location area of the GNSS receiver that corresponds to the border with reference to a three dimensional representation of a region including the presumed location area. In some embodiments, the identifying of the portion of the presumed location area of the GNSS receiver is dependent on the type of transition event as well as on the motion vector of the GNSS receiver. In some such embodiments, if the transition event is (i) LOS to NLOS, the identifying comprises identifying a band along a shadowed side of the border, the band having a width determined by the motion vector of the GNSS receiver over a period equal to the threshold duration. In some such embodiments, if the transition event is (ii) NLOS to LOS, the identifying comprises identifying a band along an illuminated side of the border, the band having a width determined by the motion vector of the GNSS receiver over a period equal to the threshold duration.

In some embodiments, the method also includes, following the identifying of the portion of the presumed location area of the GNSS receiver, combining the identified portions of the presumed location area of the GNSS receiver for each of the at least one GNSS satellite for which a transition event was identified, to obtain an identified receiver position.

In some embodiments, the method also includes, for at least one of the at least one GNSS satellites for which no transition event was identified, identifying a portion of the presumed location area of the GNSS receiver in which no border is crossed, and the combining comprises combining the identified portion of the presumed location area of the GNSS receiver corresponding to a border and the identified portions in which no border is crossed to obtain the identified receiver position.

In some embodiments, the method also includes displaying the identified receiver position at a display rate. In some such embodiments, the displaying comprises displaying the identified receiver position, for example overlaid over a two dimensional map including the presumed location area.

In some embodiments, the method also includes reporting the identified receiver position to a location remote from the GNSS receiver, such as to a remote server, a remote operator of an unmanned vehicle, or another remote device. In some such embodiments, the reporting comprises communicating the identified receiver position to the remote location over a wireless communication network.

According to an aspect of some embodiments of the invention there is also provided a device for calculating the position of a GNSS receiver, comprising:
a) a transition monitoring module, configured to, at a monitoring rate, monitor signal characteristics received by a GNSS receiver from a GNSS satellite that is located above the horizon with respect to the GNSS receiver, and to identify a transition event where the signal characteristics indicate that the GNSS receiver changes from:
   i. LOS to NLOS—having an unobstructed line of sight to the GNSS satellite to not having an unobstructed line of sight to the GNSS satellite; or
   ii. NLOS to LOS—not having an unobstructed line of sight to the to the GNSS satellite to having an unobstructed line of sight to the GNSS satellite; and
b) a location improver, configured to, upon the identification of a transition event:
   i. obtain a presumed location area of the GNSS receiver;
   ii. determine a portion of the presumed location area that corresponds to a border of a shadow cast by an object that accounts for the identified transition event; and
   iii. report the portion of the presumed location.

In some embodiments, the monitoring rate is at least as frequent as once per second. In some embodiments, the monitoring rate is at least as frequent as five times per second.

In some embodiments, the signal characteristics indicating a transition event comprise a change in signal intensity received by the GNSS receiver from a satellite. In some embodiments, the transition event where the GNSS receiver changes from (i) LOS to NLOS is identified by a reduction of not less than 5 dB in the signal intensity received from that satellite, and in some embodiments, a reduction of not less than 8 dB. In some embodiments, the transition event where the GNSS receiver changes from (ii) NLOS to LOS is identified by an increase of not less than 5 dB in the signal intensity received from that satellite, and in some embodiments, an increase of not less than 8 dB.

In some embodiments, the signal characteristics indicating a transition event comprise a change in direction of Doppler shift of a signal received by the GNSS receiver from the GNSS satellite.

In some embodiments, the location improver is configured to determine the border with reference to a three-dimensional representation of the presumed location area.

In some embodiments, the device also includes a navigation module configured to compute the presumed location area of the GNSS receiver at an area computing rate. In some such embodiments, the navigation module is also configured to display the presumed location area on a display screen at a display rate, for example overlaid over a two dimensional map including the presumed location area. In some embodiments, the navigation module is also configured to compute a motion vector of the GNSS receiver.

In some embodiments, the GNSS receiver is functionally associated with (e.g., mounted upon or within a vehicle), in some embodiments a terrestrial vehicle (e.g., automobile, truck,), a marine vehicle (e.g., boat or ship) or an aerial vehicle (e.g., fixed-wing aircraft, rotary-wing aircraft). In some embodiments, the GNSS receiver is functionally associated with (e.g., mounted upon or within) an unmanned vehicle. In some such embodiments, the unmanned vehicle comprises at least one of a self-driving automobile and an Unmanned Aerial Vehicle (UAV).

In some embodiments, the transition monitoring module is also configured to assign a timestamp to the transition event, and the location improver is configured to identify the portion of a presumed location area of the GNSS receiver corresponding to the border only if the timestamp assigned to the transition event is not older than a predetermined threshold duration.

In some embodiments, the location improver is configured to identify the portion of the presumed location area of the GNSS receiver that corresponds to the border with reference to a three dimensional representation of a region including the presumed location area. In some embodiments, the location improver is configured to identify the portion of the presumed location area of the GNSS receiver based on the type of transition event as well as on the motion vector of the GNSS receiver. In some such embodiments, if the transition event is (i) LOS to NLOS, the location improver is configured to identify a band along a shadowed side of the border, the band having a width determined by the motion vector of the GNSS receiver over a period equal to the threshold duration. In some such embodiments, if the transition event is (ii) NLOS to LOS, the location improver is configured to identify a band along an illuminated side of the border, the band having a width determined by the motion vector of the GNSS receiver over a period equal to the threshold duration.

In some embodiments, the location improver is also configured to combine identified portions of the presumed location area of the GNSS receiver for each of at least two GNSS satellites for which a transition event was identified, to obtain an identified receiver position.

In some embodiments, the location improver is also configured, for at least one GNSS satellite for which no transition event is identified, to identify a portion of the presumed location area in which no border is crossed, and to combine the identified portions corresponding to a border and the identified portions in which no border is crossed to obtain the identified receiver position.

In some embodiments, the location improver is configured to report the portion of the presumed location of the GNSS receiver, or the identified receiver position, by displaying the identified receiver position at a display rate. In some such embodiments, the location improver is configured to display the identified receiver position, for example overlaid over a two dimensional map including the presumed location area.

In some embodiments, the location improver is configured to report the portion of the presumed location of the GNSS receiver, or the identified receiver position, to a location remote from the GNSS receiver, such as to a remote server, a remote operator of an unmanned vehicle, or another remote device. In some such embodiments, the location improver communicates the identified receiver position to the remote location over a wireless communication network.

According to an aspect of some embodiments of the invention there is also provided a method for determining the position of a GNSS receiver, comprising:
a) at a monitoring rate, monitoring at least two GNSS satellites that are located above the horizon with respect to a GNSS receiver to identify a Rapid Signal Attenuation (RSAT) event corresponding to the at least two GNSS satellites;
b) using a three dimensional representation of a presumed location area of the GNSS receiver representative of at least one obstructing object in the presumed location area, computing a shadow cast by the at least one obstructing object with respect to the signal from each of the at least two satellites;
c) measuring the duration elapsed between the GNSS receiver passing a first shadow cast by the at least one obstructing object with respect to a signal from a first of the at least two GNSS satellites and a second shadow cast by the at least one obstructing object with respect to a signal from a second of the at least two GNSS satellites;
d) computing a distance traversed by the GNSS receiver during the measured duration; and
e) comparing the computed distance to distances identified in the three dimensional representation to thereby identify a lane in which the GNSS receiver is travelling.

In some embodiments, the monitoring rate is at least as frequent as once per second. In some embodiments, the monitoring rate is at least as frequent as five times per second.

In some embodiments, the method also includes computing the presumed location area of the GNSS receiver at a presumed area computing rate. In some embodiments, the computing comprises computing the presumed location area to be within 30 meters from the actual location of the GNSS receiver. In some embodiments, the computing comprises computing the presumed location area to be within 20 meters from the actual location of the GNSS receiver. In some embodiments, the computing comprises computing the presumed location area to be within 10 meters or less from the actual location of the GNSS receiver.

In some embodiments, the method also includes computing the motion vector, including the speed and direction of motion, of the GNSS receiver at a motion vector computing rate. In some embodiments, the computing the motion vector comprises estimating a velocity of the GNSS receiver such that the magnitude of the estimated velocity is within 1 kmh of the actual velocity of the GNSS receiver, and such that the direction of the estimated velocity is within a two degree error of the direction of the actual velocity of the GNSS receiver.

In some embodiments, the method also includes obtaining ephemeris data for GNSS satellites located above the horizon with respect to the GNSS receiver, which ephemeris data may include a three dimensional position in space of each GNSS satellite. In some such embodiments, the obtaining ephemeris data comprises obtaining the ephemeris data from a database located remotely from the GNSS receiver, for example using a suitable wired or wireless communication network.

In some such embodiments, the method also includes displaying the presumed location area at a display rate, for example overlaid over a two dimensional map including the presumed location area. In some embodiments, the display rate is 1 Hz.

In some embodiments, the GNSS receiver comprises a device including a display screen, a GNSS signal receiving unit, and a software component. In some such embodiments, the GNSS receiver comprises a modified smartphone.

In some embodiments, the GNSS receiver is functionally-associated with (e.g., mounted upon or within) a vehicle, in some embodiments a terrestrial vehicle (e.g., automobile, truck,), a marine vehicle (e.g., boat or ship) or an aerial vehicle (e.g., fixed-wing aircraft, rotary-wing aircraft). In some embodiments, the GNSS receiver is functionally-associate with (e.g., mounted upon or within) an unmanned vehicle. In some such embodiments, the unmanned vehicle comprises a self-driving automobile.

In some embodiments, the three dimensional representation includes a three dimensional model of the locations and structures of utility poles and other obstructing objects preset in the presumed location area. In some embodiments, the three dimensional representation is accurate to a resolution of better than 5 cm. In some embodiments, the three dimensional representation is accurate to a resolution of better than 3 cm. In some embodiments, the three dimensional representation is obtained from a remote database. In some embodiments, the three dimensional representation is computed by software housed in the GNSS receiver.

The monitoring rate may be any suitable monitoring rate. That said, in some embodiments, the monitoring rate is not less than about 60 Hz, not less than about 80 Hz, and even not less than about 100 Hz.

In some embodiments, an RSAT event is identified by a drop in the intensity of a signal received from a corresponding GNSS satellite from an intensity of at least 40 dB-Hz to an intensity lower than 25 dB-Hz.

In some embodiments, the method also comprises, following ‘b’ the computing of a shadow cast by the at least one obstructing object, for each RSAT event, constructing a virtual three dimensional ray between a known position of a satellite corresponding to the RSAT event and an estimated location at which the RSAT event occurred. In some such embodiments, the method also includes overlaying the virtual three dimensional rays constructed for different RSAT events over one another and over the three dimensional representation, such that intersections of the virtual three dimensional rays correspond to locations of obstructing objects in the three dimensional representation.

In some embodiments, ‘d’ the computing of the distance traversed by the GNSS receiver comprises computing the distance based on the measured duration elapsed and on the motion vector, and particularly the velocity, of the GNSS receiver.

In some embodiments, ‘e’ the comparing of the computed distance to distances identified in the three dimensional representations comprises comparing the computed distance to distances between the first shadow and the second shadow in each of multiple lanes represented in the three dimensional representation. In some such embodiments, the method also includes identifying the lane in which the GNSS receiver is travelling to be the lane in which the distance between the first and second shadows in the three dimensional representation is substantially equal to the computed distance.

In some embodiments, the method also includes displaying the identified lane at a display rate. In some such embodiments, the displaying comprises displaying the identified lane, for example overlaid over a two dimensional map including the presumed location area.

In some embodiments, the method also includes reporting the identified lane to a location remote from the GNSS receiver, such as to a remote server, a remote operator of an unmanned vehicle, or another remote device. In some such embodiments, the reporting comprises communicating the identified receiver position to the remote location over a wireless communication network.

According to an aspect of some embodiments of the invention there is also provided a device for determining the position of a GNSS receiver, comprising:
a) an RSAT monitoring module, configured to monitor at least two GNSS satellites that are located above the horizon with respect to a GNSS receiver to identify a Rapid Signal Attenuation (RSAT) event corresponding to the at least two GNSS satellites, at a monitoring rate;
b) a shadow identifying module, configured to use a three dimensional representation of a presumed location area of the GNSS receiver representative of at least one obstructing object in the presumed location area to compute a shadow cast by the at least one obstructing object with respect to the signal from each of the at least two satellites; and
c) a lane identifying module, configured to:
   i. measure a duration elapsed between the GNSS receiver passing a first shadow cast by an at least one obstructing object with respect to a signal from a first of the at least two GNSS satellites and a second shadow cast by at least one obstructing object with respect to a signal from a second of the at least two GNSS satellites;
   ii. compute a distance traversed by the GNSS receiver during the measured duration; and
   iii. compare the computed distance to distances identified in the three dimensional representation to thereby identify a lane in which the GNSS receiver is travelling.

In some embodiments, the lane identifying module is configured to report the identified lane in which the GNSS receiver is travelling.

In some embodiments, the monitoring rate is at least as frequent as once per second. In some embodiments, the monitoring rate is at least as frequent as five times per second.

In some embodiments, the device also includes a navigation module configured to compute the presumed location area of the GNSS receiver at a presumed area computing rate.

In some embodiments, the navigation module is configured to compute the presumed location area to be within 30 meters from the actual location of the GNSS receiver. In some embodiments, the navigation module is configured to compute the presumed location area to be within 20 meters from the actual location of the GNSS receiver. In some embodiments, the navigation module is configured to compute the presumed location area to be within 10 meters or less from the actual location of the GNSS receiver.

In some embodiments, such a navigation module is also configured to compute the motion vector, including the speed and direction of motion, of the GNSS receiver at a motion vector computing rate. In some embodiments, the navigation module is configured to estimate a velocity of the GNSS receiver such that the magnitude of the estimated velocity is within 1 kmh of the actual velocity of the GNSS receiver, and such that the direction of the estimated velocity is within a two degree error of the direction of the actual velocity of the GNSS receiver.

In some embodiments, such a navigation module is also configured to obtain ephemeris data for GNSS satellites located above the horizon with respect to the GNSS receiver, which ephemeris data may include a three dimensional position in space of each GNSS satellite. In some such embodiments, the ephemeris data is obtained from a database located remotely from the GNSS receiver, for example using a suitable wired or wireless communication network.

In some embodiments, the device also includes a display screen configured to display the presumed location area at a display rate, for example overlaid over a two dimensional map including the presumed location area. In some embodiments, the display rate is 1 Hz.

In some embodiments, the GNSS receiver comprises a device including a display screen, a GNSS signal receiving unit, and a software component. In some such embodiments, the GNSS receiver comprises a modified smartphone.

In some embodiments, the GNSS receiver is functionally associated with (e.g., mounted upon or within) a vehicle, in some embodiments a terrestrial vehicle (e.g., automobile, truck,). In some embodiments, the GNSS receiver is functionally associated with (e.g., mounted upon or within) an unmanned vehicle. In some such embodiments, the unmanned vehicle comprises at least one of a self-driving automobile.

In some embodiments, the three dimensional representation includes a three dimensional model of the locations and structures of utility poles and other obstructing objects preset in the presumed location area. In some embodiments, the three dimensional representation is accurate to a resolution of better than 5 cm. In some embodiments, the three dimensional representation is accurate to a resolution of better than 3 cm. In some embodiments, the three dimensional representation is obtained from a remote database. In some embodiments, the three dimensional representation is computed by software housed in the GNSS receiver.

The monitoring rate may be any suitable monitoring rate. That said, in some embodiments, the monitoring rate is not less than about 60 Hz, not less than about 80 Hz, and even not less than about 100 Hz.

In some embodiments, an RSAT event is identified by a drop in the intensity of a signal received from a corresponding GNSS satellite from an intensity of at least 40 dB-Hz to an intensity lower than 25 dB-Hz.

In some embodiments, the shadow identifying module is configured to construct, for each RSAT event, a virtual three dimensional ray between a known position of a satellite corresponding to the RSAT event and an estimated location at which the RSAT event occurred. In some such embodiments, the shadow identifying module is also configured to overlay the virtual three dimensional rays constructed for different RSAT events over one another and over the three dimensional representation, such that intersections of the virtual three dimensional rays correspond to locations of obstructing objects in the three dimensional representation.

In some embodiments, the lane identifying module is configured to compute the distance based on the measured duration and on the motion vector, and particularly the velocity, of the GNSS receiver.

In some embodiments, the lane identifying module is configured to compare the computed distance traversed by the GNSS receiver to distances between the first shadow and the second shadow in each of multiple lanes represented in the three dimensional representation. In some such embodiments, the lane identifying module is also configured to identify the lane in which the GNSS receiver is travelling to be the lane in which the distance between the first and second shadows in the three dimensional representation is substantially equal to the computed distance.

In some embodiments, the lane identifying module is configured to report the identified lane, by displaying the identified lane at a display rate. In some such embodiments, the lane identifying module is configured to display the identified lane, for example overlaid over a two dimensional map including the presumed location area.

In some embodiments, the lane identifying module is configured to report the identified lane to a location remote from the GNSS receiver, such as to a remote server, a remote operator of an unmanned vehicle, a vehicle control computer such as a control computer of a self-driving vehicle, or another remote device. In some such embodiments, the lane identifying module communicates the identified lane to the remote location over a wireless communication network.

Unless otherwise defined, all technical and scientific terms used herein have the same meaning as commonly understood by one of ordinary skill in the art to which the invention pertains. In case of conflict, the specification, including definitions, will take precedence.

As used herein, the terms “comprising”, “including”, “having” and grammatical variants thereof are to be taken as specifying the stated features, integers, steps or components but do not preclude the addition of one or more additional features, integers, steps, components or groups thereof. These terms encompass the terms “consisting of” and “consisting essentially of”.

As used herein, the indefinite articles “a” and “an” mean “at least one” or “one or more” unless the context clearly dictates otherwise.

As used herein, when a numerical value is preceded by the term “about”, the term “about” is intended to indicate +/−10%.

Embodiments of methods and/or devices of the invention may involve performing or completing selected tasks manually, automatically, or a combination thereof. Some embodiments of the invention are implemented with the use of components that comprise hardware, software, firmware or combinations thereof. In some embodiments, some components are general-purpose components such as general purpose computers or oscilloscopes. In some embodiments, some components are dedicated or custom components such as circuits, integrated circuits or software.

For example, in some embodiments, some of an embodiment is implemented as a plurality of software instructions executed by a data processor, for example which is part of a general-purpose or custom computer. In some embodiments, the data processor or computer comprises volatile memory for storing instructions and/or data and/or a non-volatile storage, for example, a magnetic hard-disk and/or removable media, for storing instructions and/or data. In some embodiments, implementation includes a network connection. In some embodiments, implementation includes a user interface, generally comprising one or more of input devices (e.g., allowing input of commands and/or parameters) and output devices (e.g., allowing reporting parameters of operation and results.

### BRIEF DESCRIPTION OF THE FIGURES

Some embodiments of the invention are described herein with reference to the accompanying figures. The description, together with the figures, makes apparent to a person having ordinary skill in the art how some embodiments of the invention may be practiced. The figures are for the purpose of illustrative discussion and no attempt is made to show structural details of an embodiment in more detail than is necessary for a fundamental understanding of the invention. For the sake of clarity, some objects depicted in the figures are not to scale.

In the Figures:

FIG. 1 is a pictorial illustration of a global navigation satellite system;

FIGS. 2A, 2B and 2C each depict an urban area, and show different areas as being illuminated by signals from a given GNSS satellite or being shadowed by a shadow cast by an obstructing object such as a building caused by the signals transmitted from the satellite;

FIG. 3 is a schematic depiction of an embodiment of a GNSS receiver according to the teachings herein, suitable for implementing embodiments of the method according to the teachings herein;

FIGS. 4A and 4B, taken together, are a flow chart of an embodiment of a method for improving global navigation satellite system accuracy according to an embodiment of the teachings herein;

FIG. 5 is a pictorial illustration of an intersection in which navigation accuracy enhancement such as lane detection is required;

FIG. 6 depicts GNSS satellite shadows within a region as used for navigation accuracy enhancement according to an embodiment of the method of the teachings herein;

FIG. 7 is a graphic depiction of signal strengths of visible satellites according to an embodiment of the teachings herein;

FIG. 8 is a graphic depiction of carrier power to noise ratio for a single satellite over time, indicating the threshold between the satellite being an LOS satellite and the satellite being an NLOS satellite according to an embodiment of the teachings herein;

FIG. 9 is a graphic depiction of signal attenuation in 10 Hz from 3 different satellites according to an embodiment of the teachings herein;

FIG. 10 is a schematic depiction of an embodiment of a GNSS receiver according to the teachings herein, suitable for implementing embodiments of car lane detection using GNSS signals according to an embodiment of the teachings herein;

FIGS. 11A and 11B, taken together, are a flow chart of an embodiment of a method for accurate lane detection using GNSS satellite shadows according to an embodiment of the teachings herein; and

FIG. 12 is a schematic depiction of a computation for lane detection using GNSS devices according to an embodiment of the teachings herein.

### DESCRIPTION OF SOME EMBODIMENTS OF THE INVENTION

At any given time, a substantial number of GNSS satellites are located above the horizon relative to a given GNSS receiver on the earth's surface and therefore potentially have line of sight with the receiver.

In some instances, a GNSS receiver has an unobstructed line of sight to a GNSS satellite that is located above the horizon so that the receiver is illuminated by the signals transmitted by the satellite. Herein, in such a state the satellite is termed an LOS-satellite.

In some instances, the line of sight between a GNSS receiver and a GNSS satellite that is located above the horizon is obstructed by an obstructing object, for example by a natural object such as a mountain or by an artificial object such as a building. In such cases, the receiver is found in the shadow cast by the obstructing object caused by the signals transmitted from the satellite. Herein, in such a state the satellite is termed an NLOS-satellite. A typical GNSS receiver is able to receive signals transmitted from NLOS-satellites with which the line of sight is obstructed by reflection of the signals, but at low intensities, e.g., at least 5 dB lower than the intensity of a signal from an LOS-satellite.

In some embodiments of the teachings of PCT/IB2011/055899 published as WO2012/085876 of the Applicant, which description and figures are included by reference as if fully set-forth herein, is disclosed the use of knowledge of a location at which a given satellite is found at a given time and a 3D representation of the area in which the receiver is found, to determine which portions of the area are shadowed by obstructing object and which are illuminated by signals transmitted from the satellite. By determining whether, at the given time, the satellite is an LOS (so the receiver is expected to be illuminated) or an NLOS satellite (so the receiver is expected to be in a shadow), the likely position of the receiver in the area can be more accurately determined.

Herein is disclosed a method and device for determining the position of a GNSS receiver that in some embodiments is based on detecting a transition event in which a satellite changes from being an LOS satellite to being an NLOS satellite, or from being an NLOS satellite to being an LOS satellite. Such a transition event is correlated with the receiver crossing a border between an illuminated area and a shadowed area. Since at a given time, such borders are relatively well-defined, the position of the GNSS receiver can be determined with some accuracy.

The principles, uses and implementations of the teachings herein may be better understood with reference to the accompanying description and figures. Upon perusal of the description and figures present herein, one skilled in the art is able to implement the invention without undue effort or experimentation.

Before explaining at least one embodiment of the invention in detail, it is to be understood that the invention is not limited in its applications to the details of construction and the arrangement of the components and/or methods set forth in the following description and/or illustrated in the drawings and/or the Examples. The invention can be implemented with other embodiments and can be practiced or carried out in various ways. It is also understood that the phraseology and terminology employed herein is for descriptive purpose and should not be regarded as limiting.

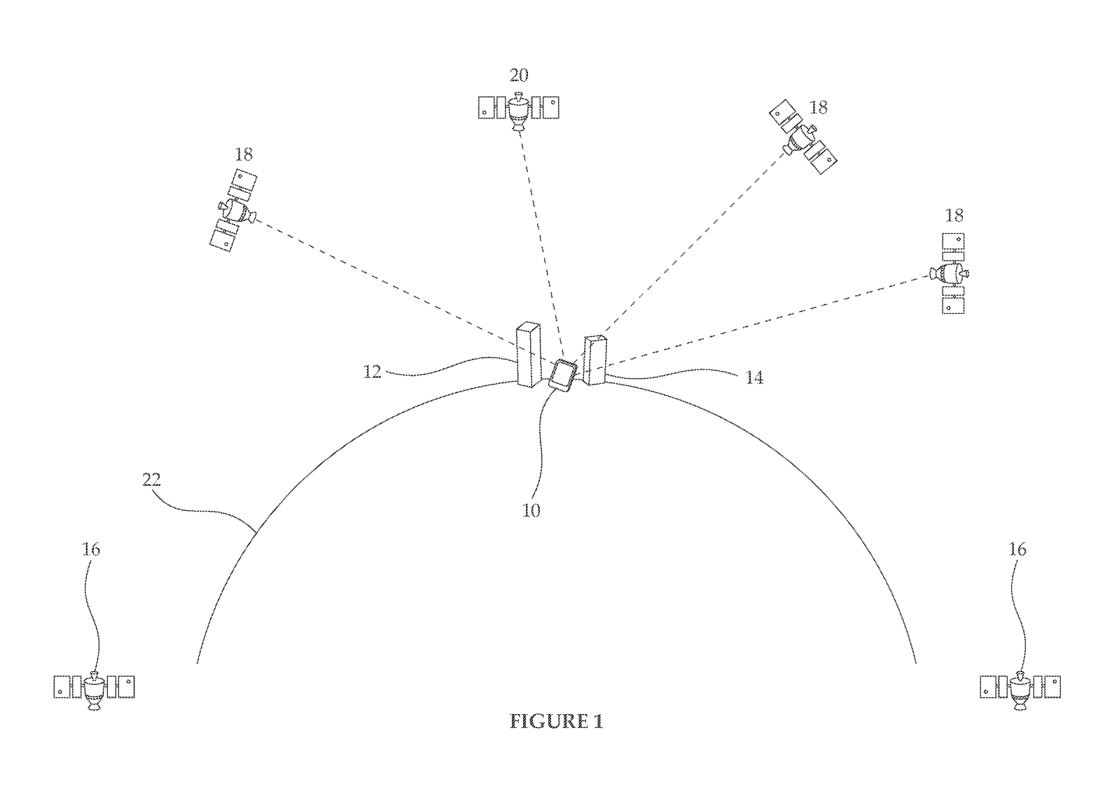

Reference is now made to FIG. 1, which is a pictorial illustration of aspects of the teachings herein. As seen in FIG. 1, a GNSS receiver 10 of a global navigation satellite system is located in an urban area which includes several tall buildings, indicated by reference numerals 12 and 14. A plurality of GNSS satellites of a global navigation satellite system, indicated by reference numerals 16, 18, and 20, are seen orbiting the Earth 22.

As seen in FIG. 1, the satellites 16 are below the horizon with respect to receiver 10, and therefore are invisible to receiver 10. Receiver 10 may be able to receive signals from satellites 18 and 20, which are above the horizon relative to receiver 10. Thus, each satellite 18 and 20 that is above the horizon can be classified as a line of sight (LOS) satellite or a non line of sight (NLOS) satellite relative to receiver 10, depending on whether or not the line of sight to receiver 10 is blocked.

As seen in FIG. 1, satellite 20 is a LOS-satellite, having an unblocked line of sight to receiver 10. Satellites 18 are NLOS satellites, because the respective lines of sight between each satellite 18 and receiver 10 are blocked by buildings 12 and/or 14.

The signal strength received from an LOS satellite such as satellite 20 is typically no less than 3 dB from the maximum signal strength, and is dependent on factors such as weather conditions and the location of a receiver such as receiver 10 on the face of Earth. Signals transmitted by NLOS satellites such as satellites 18 may be received indirectly by receiver 10 through reflections from various surfaces in an urban area. The signal strength received from an NLOS satellite is typically less than 5 dB below the maximum signal strength.

Typically, location calculations which are based on signals received from NLOS satellites such as satellites 18, or that take into consideration signals from NLOS satellites, are error prone. This is due to the fact that such signals are received through reflections off one or more objects surrounding the receiver 10, such as the walls of a building 12. As a result, the pseudoranges determined by receiver 10 using signals received from NLOS satellites 18 are different from the true pseudoranges that corresponds to the distance to those satellites 18.

As known in the art, it is possible to determine which of satellites 18 and 20, that are located above the horizon with respect to receiver 10, are LOS satellites and which are NLOS satellites relative to receiver 10, for example as described in U.S. Pat. No. 7,577,445 and U.S. Patent Application Publication No. 2005/0124368.

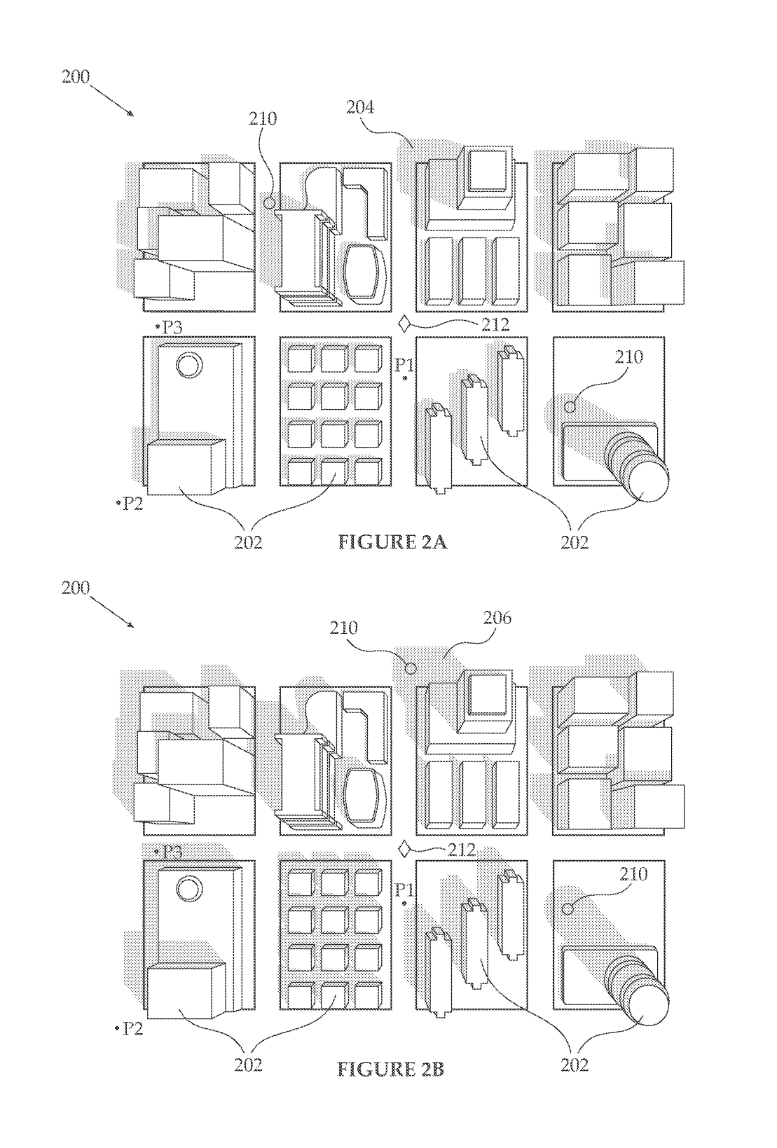

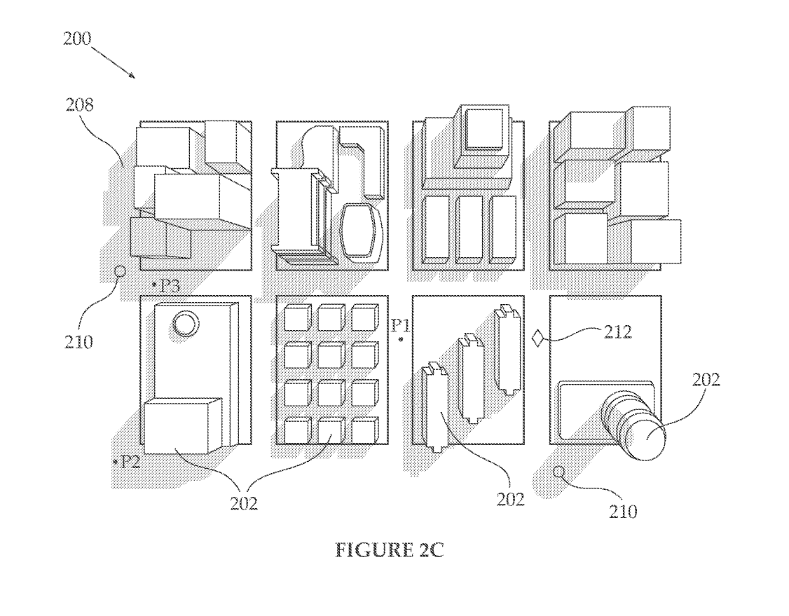

Reference is now made to FIGS. 2A, 2B, and 2C, which are schematic representations of a three-dimensional map of one urban area 200 overlaid with shading maps associated with three satellites according to an embodiment of the teachings herein.

As seen in FIGS. 2A, 2B, and 2C, the urban area 200 includes a plurality of above-ground constructions, such as buildings 202, which are similar to buildings 12 and 14 of FIG. 1. In each of FIGS. 2A, 2B and 2C, the three-dimensional map of urban area 200 is overlaid with a shading map associated with a different one of GNSS satellites S1, S2, and S3, (not shown). The shading map 204 of FIG. 2A, shading map 206 of FIG. 2B, and shading map 208 of FIG. 2C, differ, and each shows portions of area 200 that are illuminated by transmissions from the associated satellite, and portions of area 200 that are located in a shadow cast by buildings 202 by the associated satellite. The exact size and shape of the each shaded portion in each of shading maps 204, 206, and 208, as well as the borders between the shaded and illuminated areas, are dependent on the azimuth position of the associated satellites S1, S2, and S3 at any given time. The shading maps 204, 206, and 208 may be generated using any suitable shading algorithm, such as that provided by the OpenGL and OpenGL ES-2 graphics libraries.

The shadowed regions in shading maps 204, 206, and 208 represent regions of the urban area at which a GNSS receiver would have no line of sight to the associated satellite, for example because the line of sight is blocked by buildings 202, while the illuminated regions represent regions at which a GNSS receiver would have a line of sight to the satellite. Stated otherwise, in each of FIGS. 2A, 2B, and 2C, the respective one of satellites S1, S2, and S3 is a NLOS satellite, similar to satellites 18 of FIG. 1, with respect to a GNSS receiver, such as receiver 10 of FIG. 1, located in a shadowed region, such as a position 210, but is a LOS satellite, similar to satellite 20 of FIG. 1, with respect to a GNSS receiver located in an illuminated region, such as a position 212.

As seen in FIGS. 2A, 2B, and 2C, each figure is marked with positions P1, P2, and P3, such that a corresponding satellite is LOS or NLOS with respect to a GNSS receiver located at each of the positions. Specifically:

in FIG. 2A it is seen that satellite S1 is a LOS satellite with respect to a GNSS receiver located at positions P1, P2 or P3, since all of positions P1, P2, and P3 are located in illuminated regions of shading map 204;

in FIG. 2B it is seen that satellite S2 is a NLOS satellite with respect to a GNSS receiver located at a position P3 which is in a shadowed region of shading map 206, but is a LOS satellite with respect to a GNSS receiver located at positions P1 or P2, which are in an illuminated region of shading map 206; and

in FIG. 2C it is seen that satellite S3 is a NLOS satellite with respect to a GNSS receiver located at positions P2 or P3 which are in shadowed regions of shading map 208, but is a LOS satellite with respect to a GNSS receiver located at position P1 which is in an illuminated region of shading map 208.

By classifying each of S1, S2 and S3 as a LOS or NLOS satellite (for example according to received signal strength) by a receiver situated in an a priori unknown position in the vicinity of positions P1, P2, and P3, and by noting when a specific satellite makes a transition from being an LOS satellite to being an NLOS satellite, or from being an NLOS satellite to being an LOS satellite, with respect to a give GNSS receiver, it is possible to narrow the probable locations of the GNSS receiver in an area to those locations in the area that are along a border between an illuminated region and a shadowed region of the area relative to that specific satellite.

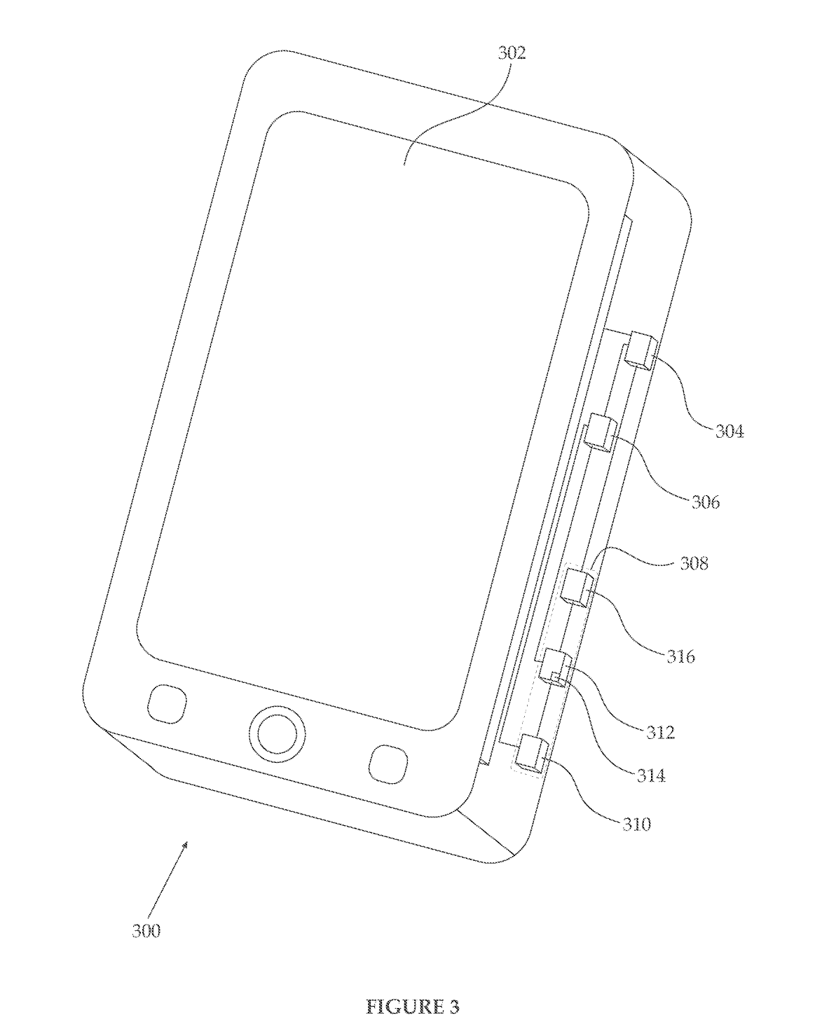

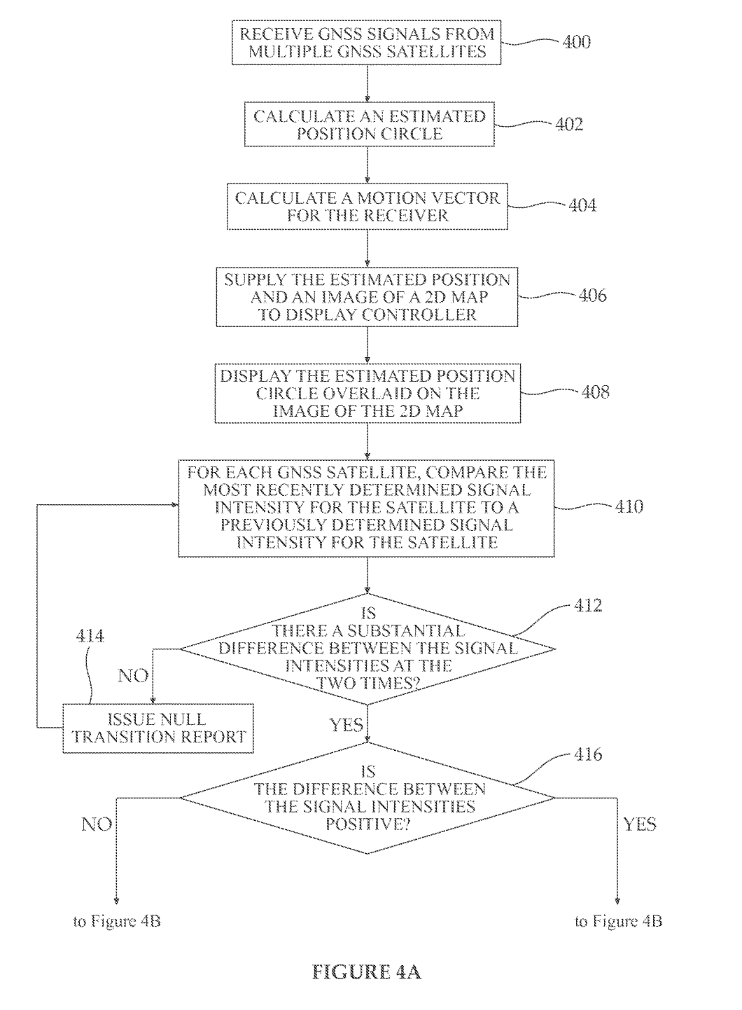

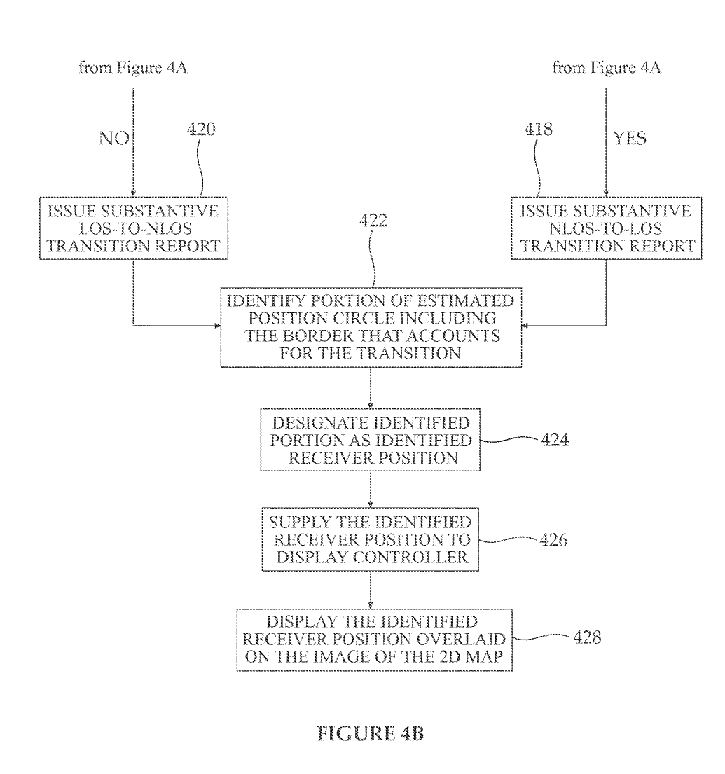

Reference is now made to FIG. 3, which is a schematic depiction of an embodiment of a GNSS receiver according to the teachings herein, suitable for implementing embodiments of the method according to the teachings herein, and to FIGS. 4A and 4B, which, taken together, are a flow chart of an embodiment of a method for improving global navigation satellite system accuracy according to an embodiment of the teachings herein.

According to an aspect of some embodiments of the invention there is provided a method for determining the position of a GNSS receiver, comprising:
a) from a GNSS receiver, at a monitoring rate, monitoring at least one GNSS satellite that is located above the horizon with respect to the GNSS receiver to identify a transition event where the GNSS receiver changes from:
   i. LOS to NLOS—having an unobstructed line of sight to at least one specific satellite of the at least one GNSS satellite to not having an unobstructed line of sight to the at least one specific satellite; or
   ii. NLOS to LOS—not having an unobstructed line of sight to at least one specific satellite of the at least one GNSS satellite to having an unobstructed line of sight to the at least one specific satellite;
b) if a transition event is identified, identifying a portion of a presumed location area of the GNSS receiver that corresponds to a border of a shadow cast by an object that accounts for the transition event.

According to an aspect of some embodiments of the invention there is also provided a device for calculating the position of a GNSS receiver, comprising:
a) a transition monitoring module, configured to, at a monitoring rate, monitor signal characteristics received by a GNSS receiver from a GNSS satellite that is located above the horizon with respect to the GNSS receiver, and to identify a transition event where the signal characteristics indicate that the GNSS receiver changes from:
   i. LOS to NLOS—having an unobstructed line of sight to the GNSS satellite to not having an unobstructed line of sight to the GNSS satellite; or
   ii. NLOS to LOS—not having an unobstructed line of sight to the to the GNSS satellite to having an unobstructed line of sight to the GNSS satellite; and
b) a location improver, configured to, upon the identification of a transition event:
   i. obtain a presumed location area of the GNSS receiver;
   ii. determine a portion of the presumed location area that corresponds to a border of a shadow cast by an object that accounts for the identified transition event; and
   iii. report the portion of the presumed location.

Turning to FIG. 3, it is seen that a GNSS receiver 300 according to an embodiment of the teachings herein includes a display screen 302, a display controller 304 and a prior art GNSS navigation module 306, for example, such as on the Snapdragon S4 SoC by Qualcomm of San Diego, Calif., USA, functionally associated therewith. In the illustrated embodiment, the GNSS receiver 300 comprises a modified smartphone, such as a Galaxy S III by Samsung of Seoul, South Korea. However, any other suitable GNSS receiver may be modified to include an implementation of the teachings herein. Specifically, in some embodiments, a GNSS receiver 300 according to the teachings herein comprises a GNSS receiver functionally associated with (e.g., mounted upon or within a vehicle), in some embodiments a terrestrial vehicle (e.g., automobile, truck,), a marine vehicle (e.g., boat or ship) or an aerial vehicle (e.g., fixed-wing aircraft, rotary-wing aircraft). In some embodiments, the GNSS receiver is functionally associated with (e.g., mounted upon or within) an unmanned vehicle. In some such embodiments, the unmanned vehicle is a self-driving automobile or an Unmanned Aerial Vehicle (UAV), also known as a drone, which is modified to implement the teachings herein, e.g., includes hardware and/or software and/or firmware according to the teachings herein as described further hereinbelow.

Navigation module 306 is configured to receive GNSS signals from a plurality of GNSS satellites located above the horizon with respect to GNSS receiver 300, such as the American GPS satellites, as indicated by reference numeral 400 in FIG. 4A, and to calculate a presumed location area of receiver 300 as an estimated position circle in the usual way, at reference numeral 402 of FIG. 4A. In the usual way, navigation module 306 also calculates the motion vector (speed and direction of motion) of receiver 300, at reference numeral 404 of FIG. 4A.

In some embodiments, at reference numeral 406 of FIG. 4A, navigation module 306 supplies the estimated position circle and an image of a portion of a stored 2D map that includes the estimated position circle to display controller 304. Display controller 304 displays the estimated position circle overlaid on an image of a 2D map on display screen 302 at a display rate, typically 1 Hz, at reference numeral 408 of FIG. 4A, thus reporting the estimated position circle to a user of the GNSS receiver.

As seen in FIG. 3, GNSS receiver 300 further includes a software component 308, such as a program written in the usual way, which is configured to implement embodiments of the teachings herein. Software component 308 includes a satellite state monitor 310 functionally associated with navigation module 306, a location-improving module 312 including a 3D representation 314 of the area in which receiver 300 is found, such as a city, and functionally associated with navigation module 306 and with satellite state monitor 310, and an improved-position display module 316 functionally associated with location-improving module 312 and with display controller 304.

Satellite state monitor 310 is configured to monitor all GPS satellites that are located above the horizon with respect to receiver 300 to identify a transition event where a LOS satellite becomes a NLOS satellite or when a NLOS satellite becomes a LOS satellite. A transition event in which a LOS satellite becomes a NLOS satellite is, for example, an event in which receiver 300, which was located in an illuminated region of an area, such as at position 212 of FIG. 2A, moves to cross a border into a shadow cast by an object in the area, such as to position 210 of FIG. 2A. A transition event in which a NLOS satellite becomes a LOS satellite is, for example, an event in which receiver 300, which was located in a shadow cast by an object in the area, such as to position 210 of FIG. 2A, moves to cross a border into an illuminated region of an area, such as at position 212 of FIG. 2A.

In some embodiments, satellite state monitor 310 monitors the satellites for a transition at a monitoring rate. The monitoring rate may be any suitable monitoring rate. That said, in some embodiments, the monitoring rate is not less than 10 Hz, not less than 20 Hz, not less than 50 Hz, or even not less than 100 Hz.

In some embodiments, a transition event relative to a given satellite is identified by a change in signal intensity received by receiver 300 from the given satellite which change is above a predetermined threshold. In some such embodiments, the change in signal intensity is greater than a 5 dB change, greater than an 8 dB change, or even greater than a 15 dB change.

Specifically, as seen at reference numeral 410 of FIG. 4A, at a suitable monitoring rate, for each GNSS satellite X that is located above the horizon with respect to receiver 300, satellite state monitor 310 compares the most recently determined signal intensity for satellite X (the variable Iₓ(t)), which is typically the signal intensity of the signal most recently received from satellite X, to a previously determined signal intensity for satellite X (for example the variable Iₓ(t−1)), which is typically the signal intensity of a previous signal received from satellite X, to determine the difference between the detected signal intensities at the two times (for example, Delta(Iₓ)=Iₓ(t)−Iₓ(t−1)) and to determine whether a substantial difference is found between the signal intensities at the two times, at reference numeral 412 of FIG. 4A.

If no substantial difference in signal intensity is found, that is to say |Delta(Iₓ|<threshold, satellite state monitor 310 issues a null transition report to location-improving module 312, for example having the format “Satellite X crossed no border”, at reference numeral 414 in FIG. 4A, and continues to monitor the signal intensities received from satellite X at different times.

Otherwise, if a substantial difference is signal intensity is found, the sign of the difference in signal intensity is checked to determine the transition direction, at reference numeral 416 of FIG. 4A. A NLOS to LOS transition is indicated by a substantial increase in signal intensity, or by a positive value of Delta(Iₓ), while a LOS to NLOS transition is indicated by a substantial decrease in signal intensity, or by a negative value of Delta(Iₓ).

A substantial increase in signal intensity, i.e., Delta(Iₓ)>threshold, and, in some embodiments, Delta(Iₓ) not less than 5 dB, indicates a transition event where satellite X has changed from being a NLOS satellite relative to receiver 300, such that receiver 300 has an obstructed line of sight to satellite X, to being a LOS satellite relative to receiver 300, such that receiver 300 has an unobstructed line of sight to satellite X. In other words, a substantial increase in signal intensity indicates that receiver 300 has crossed a border from a region in which a shadow cast by an object obstructs the signal transmitted by satellite X, to a region illuminated by the signal transmitted by satellite X. Thus, upon identification of a substantial increase in signal intensity, satellite state monitor 310 issues a substantive transition report to location-improving module 312, for example having the format “Satellite X crossed border NLOS to LOS”, at reference numeral 418 of FIG. 4B.

A substantial decrease in signal intensity, i.e., Delta(Iₓ)<−threshold, and, in some embodiments, Delta(Iₓ) not more than −5 dB, indicates a transition event where satellite X has changed from being a LOS satellite relative to receiver 300, such that receiver 300 has an unobstructed line of sight to satellite X, to being a NLOS satellite relative to receiver 300, such that receiver 300 has an obstructed line of sight to satellite X. In other words, a substantial decrease in signal intensity indicates that receiver 300 has crossed a border from a region illuminated by the signal transmitted by satellite X, to a region in which a shadow cast by an object obstructs the signal transmitted by satellite X. Thus, upon identification of a substantial decrease in signal intensity, satellite state monitor 310 issues a substantive transition report to location-improving module 312, for example having the format “Satellite X crossed border LOS to NLOS”, at reference numeral 420 of FIG. 4B.

In some cases, a signal from satellite X was receiver at time t−1, but no signal was received at time t, or a signal was received from satellite X at time t, but no signal was received at time t−1. Such an event may be resolved in any suitable manner. In some embodiments, such an event may be resolved by assigning a signal intensity of 0 dB to a time at which no signal was received, and computing transitions using that signal intensity value.

As mentioned above, location-improving module 312 is functionally associated with satellite state monitor 310 and with navigation module 306, and includes pre-stored 3D representation 314 of the area or city in which receiver 300 is located.

As seen at reference numeral 422 of FIG. 4B, if a substantive transition report is issued, regardless of the type of transition identified in the substantive transition report, location-improving module 312 identifies a portion of the estimated position circle that corresponds to a border between a region in which a shadow cast by an object obstructs the signal transmitted by satellite X to a region illuminated by the signal transmitted by satellite X, which border was crossed during the transition event. The border is identified with reference to 3D representation 314, and the identified portion of the estimated position circle is designated as an identified receiver-position, at reference numeral 424 of FIG. 4B. A specific exemplary implementation of a method for identifying the portion of the estimated position circle and for designating the identified receiver-position is described hereinbelow.

In some embodiments, location-improving module 312 continuously receives the issued transition reports from satellite state monitor 310. Location-improving module 312 additionally receives from navigation module 306 the computed estimated position circles and motion vector of receiver 300, including the speed and direction of motion of receiver 300, as well as ephemeris data, including coordinates, of the GNSS satellites that are located above the horizon with respect to receiver 300.

For each satellite that is located above the horizon with respect to receiver 300, location-improving module 312 stores a single substantive transition report with a timestamp when the report was stored. An older substantive transition report with associated timestamp is overwritten by a newer substantive transition report and associated timestamp relating to the same satellite.

Thus, immediately preceding a given reporting event, location-improving module 312 may have no stored substantive transition reports (no shadowed/illuminated borders crossed in the preceding second) or any number of stored substantive transition reports up to the number of satellites that are located above the horizon with respect to receiver 300.

Immediately preceding a given reporting event, for each satellite for which there is a stored substantive transition report that is not older than a predetermined threshold duration, for example one second, location-improving module 312 calculates with reference to 3D representation 314 the regions of the estimated position circle that are illuminated by signals of satellite X and in which satellite X would be a LOS satellite with respect to receiver 300, and the regions of the estimated position circle that are shadowed from receipt of signals of satellite X by an obstructing object, and in which satellite X would be a NLOS satellite with respect to receiver 300 and are shadowed. Some suitable methods for performing such calculation are discussed in PCT/IB2011/055899 published as WO2012/085876 and in the introduction herein. From these calculations, the locations of borders between the illuminated regions and the shaded regions of the estimated position circle are easily found.

For each satellite X for which there is a stored substantive transition report of format “Satellite X crossed border NLOS to LOS” that is not older than the threshold duration, location-improving module 312 designates as identified receiver-position with respect to satellite X portions of the estimated position circle that constitute a band along the illuminated side of the found border, the band having a width determined by the motion vector of receiver 300 over a period equal to the threshold duration.

Similarly, for each satellite X for which there is a stored substantive transition report of format “Satellite X crossed border LOS to NLOS” that is not older than the threshold duration, location-improving module 312 designates as identified receiver-position with respect to satellite X portions of the estimated position circle that constitute a band along the shadowed side of the found border, the band having a width determined by the motion vector of receiver 300 over a period equal to the threshold duration.

Location-improving module 312 then combines all the identified receiver-position with respect to satellite X portions of the estimated position circle for all the satellites X for which there is a stored substantive transition report that is not older than the threshold duration, and designates the combined portions of the estimated position circle as the identified receiver-position in accordance with the teachings herein.

In some embodiments, location-improving module 312 additionally accounts for the evidence supplied by those satellites for which there is no stored substantive transition report that is not older than the threshold duration. Specifically, in some such embodiments, it is assumed that since no transition event relating to a given satellite Y was detected, a LOS satellite Y remained a LOS satellite while a NLOS satellite Y remained a NLOS satellite. Accordingly, location-improving module 312 designates portions of the estimated position circle that do not require a crossing of a border between shadowed and illuminated regions that change of state of satellite from NLOS to LOS or LOS to NLOS as identified-receiver position with respect to satellite Y and excludes portions of the estimated position circle that require a crossing of such a border from identified-receiver position with respect to satellite Y. Subsequently, location-improving module 312 combines all identified receiver-position with respect to satellite X and identified receiver-position with respect to satellite Y to designate the identified receiver-position in accordance with the teachings herein.

The designated identified receiver-position is transferred to improved-position display module 316 at a reporting rate. As mentioned above, improved-position display module 316 is functionally associated with location-improving module 312 and with display controller 304.

Improved-position display module 316 is configured to transfer the identified receiver position received from location-improving module 312 to display controller 304 for display to a user of GNSS receiver 300 on display screen 302.

Specifically, during use of navigation module 306, navigation module 306 calculates the estimated position circle and display controller 304 displays the estimated position circle overlaid on an image of a 2D map on display screen 302 at a display rate, typically 1 Hz.

When software component 308 is activated to implement the teachings herein, improved-position display module 316 provides display controller 304 with the identified receiver position received from location-improving module 312 at the display rate, as seen at reference numeral 426 of FIG. 4B. Display controller 304 then displays estimated position circle overlaid on an image of a 2D map as usual, but with the identified receiver position marked differentially, for example in a different color or using different shading, at reference numeral 428 of FIG. 4B.

In the embodiment described above, the receiver position calculated in accordance with the teachings herein and designated as the identified receiver position, is displayed to a user of receiver 300 on display screen 302 together with a presumed location area, such as the estimated position circle computed by navigation module 306. In some embodiments, the receiver position calculated in accordance with the teachings herein is displayed on a display screen, without a presumed location area. In some embodiments, the receiver position calculated in accordance with the teachings herein is used as input for an improved subsequent calculation of a presumed location area, for example, used as input for a dead-reckoning system and/or an inertial navigation system.

In some embodiments, in which there is no human user viewing display screen 302 of receiver 300, such as when receiver 300 is installed in a UAV or an unmanned automobile, the receiver position calculated in accordance with the teachings herein and designated as the identified receiver-position is not displayed on display screen 302. In some such embodiments, the receiver position calculated in accordance with the teachings herein is communicated to a controller of the unmanned vehicle, such as via a wired communication network, wireless communication network or any suitable communication method.

In the embodiment described above, a transition event is identified by a substantial change in the intensity of a signal received from a GNSS satellite. In some embodiments, a transition event is identified by a change in direction of the Doppler shift of a signal received by the receiver from a satellite. Specifically, the Doppler shift of a signal received from a LOS satellite is towards higher frequency when the receiver moves towards the satellite and towards lower frequency when the receiver moves away from the satellite. However, often the direction of the Doppler shift of a signal received from a NLOS satellite is the opposite because the receiver receives the signal after reflection off a reflecting object. In some such embodiments, a transition event is identified exclusively by a change in direction of Doppler shift. In some such embodiments, a transition event is identified both by a change in direction of Doppler shift and by a change in intensity of a signal received from a satellite.

Some embodiments of the invention relate to methods and devices for accurately determining a position of an object, and specifically to methods and devices for determining the lane in which an object, such as a vehicle, is located. In some embodiments, the position of the object is determined using LOS and NLOS satellites as described above.

Herein is also disclosed a method and device for determining the lane in which an object (such as a vehicle, especially a terrestrial vehicle) is located that in some embodiments is based on detecting a transition event in which a satellite changes from being an LOS satellite to being an NLOS satellite, or from being an NLOS satellite to being an LOS satellite. Such a transition event is correlated with a GNSS receiver functionally associated with the object passing a shadow-forming utility pole or other obstruction, causing the GNSS receiver to lose the line of sight to the satellite for a short duration.

Some embodiments of the teachings herein provide a method for lane detection based solely on identifying areas in which the signal from a GNSS satellite is shadowed by an obstructing object, and matching the area to a shadowing object present in the vicinity of a GNSS receiver. The teachings herein further provide for rapid classification of satellites as LOS or NLOS, thereby enabling detection of narrow obstacles, for example narrower than 1 meter, at a velocity of 120 kilometers per hour (kmh). Such high speed detection enables the construction of an accurate lane detection algorithm using utility pole identification.

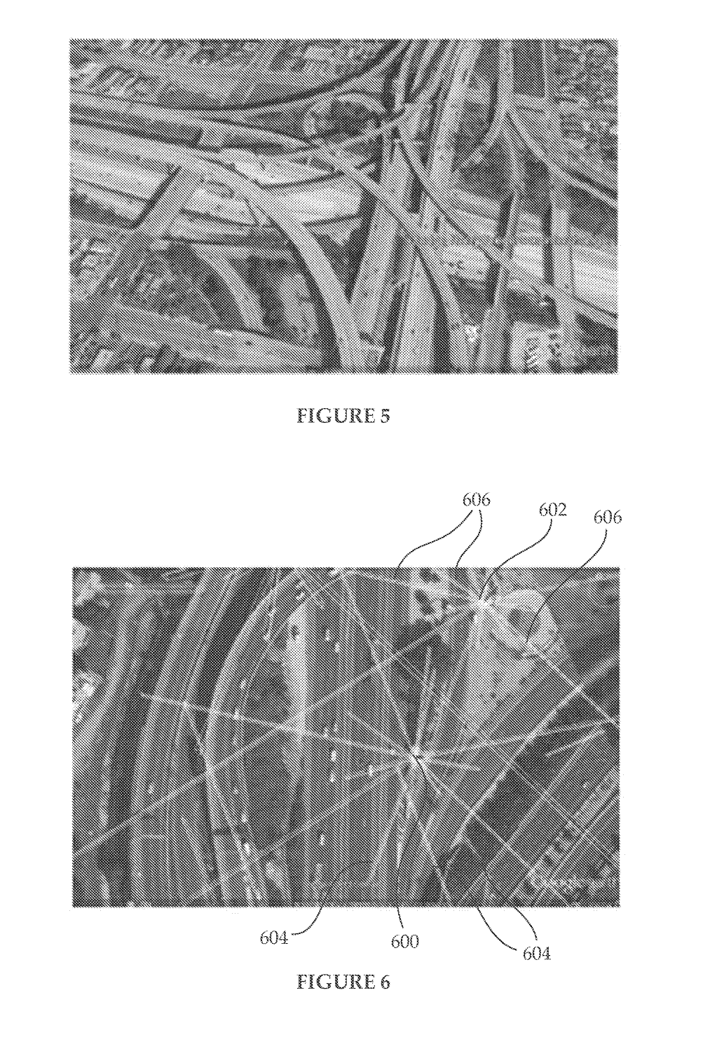

Reference is now made to FIG. 5, which is a pictorial illustration of an intersection in which navigation accuracy enhancement such as lane detection is required, and to FIG. 6, which depicts GNSS satellite shadows as used for navigation accuracy enhancement according to an embodiment of the method of the teachings herein.

Typical highways and interchanges, such as that shown in FIG. 5, are characterized by a relatively open sky, without large obstructions such as buildings, particularly in upper lanes of interchanges, and by the presence of many light and utility poles. As discussed hereinabove with reference to FIG. 5, the relatively open sky and lack of obstructions result in GNSS position estimations using standard GNSS devices and procedures being fairly accurate. In such interchanges, when a GNSS receiver is located in the shadow of a utility or light pole, a specific satellite may be an NLOS satellite with respect to the receiver, similarly to when the GNSS receiver is located in the shadow of a building, as described above with reference to FIG. 1.

FIG. 6 illustrates two utility poles 600 and 602, and respective shadows 604 and 606 cast by the utility poles 600 and 602 with respect to multiple satellites, not shown. As can be seen, the shadows 604 all intersect at utility pole 600, and shadows 606 all intersect at utility pole 602. As will be explained in further detail hereinbelow, the fact that all the shadows cast by a given utility pole form rays coming out of an intersection point at the utility pole is significant in being able to detect the lane in which the object is moving.

The method of the teachings herein requires the ability to distinguish between LOS and NLOS satellites at the GNSS receiver, and requires the locations and dimensions of the utility poles to be known, in order to improve GNSS position accuracy and to enable robust lane detection.

The positions and heights of utility poles, as well as of other types of obstructing objects such as navigation signs and bridges located along the road or intersection where the method of the teachings herein is implemented, can be obtained in numerous ways.

In some embodiments, information regarding obstructing objects such as utility poles, navigation signs, and bridges, is obtained from 3D Geographic Information Systems (GIS) and/or from Light Detection and Ranging (LIDAR) photographs.

In some embodiments, digital three dimensional models of the obstructing objects are generated using standard graphic modeling tools, such as 3D-CAD tools including Google SketchUp and/or AutoCAD. In some embodiments, the models are then implemented in GIS software, such as Google Earth.

In some embodiments, information regarding the obstructing objects for generating such models is obtained by using GNSS satellite signals to create a three-dimensional map of the area, including the obstructing objects, for example as described in PCT/IB2011/055899 published as WO2012/085876 of the Applicant.

Once models of obstructing objects are generated or obtained, the models enable prediction of the state of each satellite as an LOS satellite or as an NLOS satellite given ephemeris data, or an estimated position, of a GNSS receiver. Alternately, the state of a satellite as an LOS satellite or as an NLOS satellite with respect to a GNSS receiver can be computed using other methods known in the art, such as those disclosed in the PCT Patent Application No. PCT/IB2013/050063 filed 3 Jan. 2013 of the Applicant.

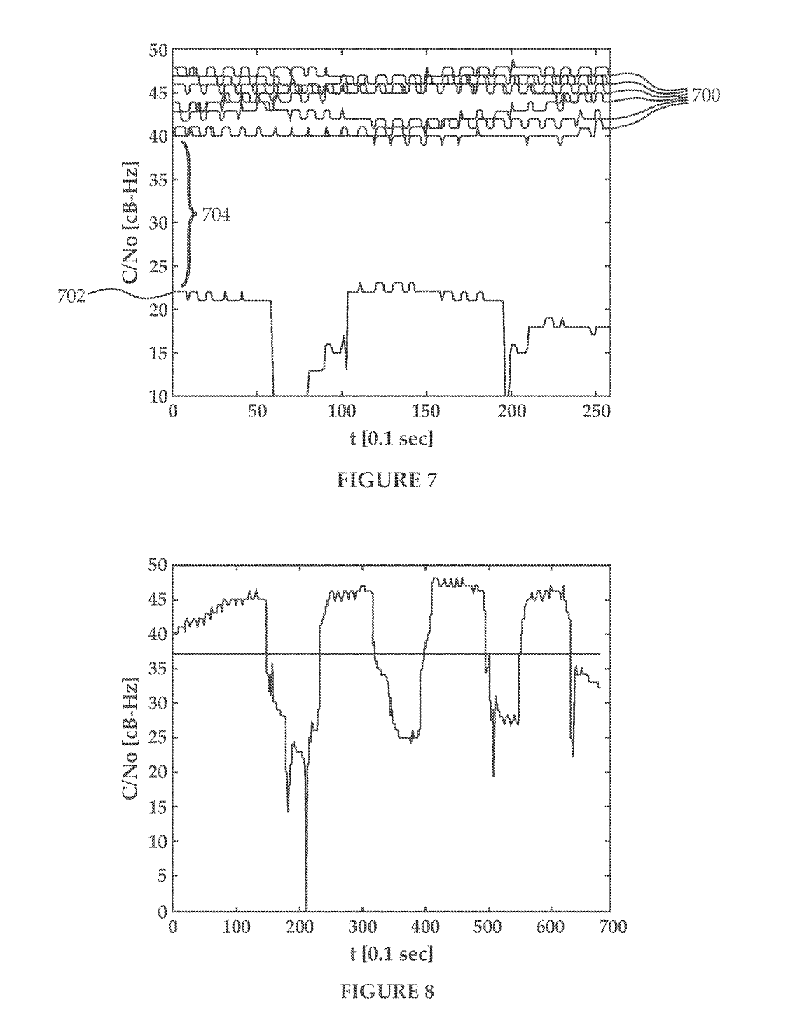

Reference is now made to FIG. 7, which is a graphic depiction of signal strengths of visible satellites according to an embodiment of the teachings herein, and to FIG. 8, which is a graphic depiction of carrier power to noise ratio for a single satellite over time, indicating the threshold between the satellite being an LOS satellite and the satellite being an NLOS satellite according to an embodiment of the teachings herein.

With respect to determination of the LOS or NLOS status of a give satellite with respect to a GNSS receiver based on a narrow obstructing object, such as a utility pole, the signal strength sampling rate of the GNSS receiver is crucial for obtaining reasonably accurate results. It is well known that the carrier frequency of typical GNSS receivers is within the range of 1.2-1.6 GHz. Such frequencies suffer from signal attenuation in NLOS conditions, as is well known in the art. Furthermore, though GNSS satellites send a time synchronization signal every 30 seconds, the signal strength is a continuous value and can be extrapolated at a rate of 10-100 Hz or faster. Commercial GNSS receivers and devices enable extraction of the receiver's carrier power to noise density (C/NO) measurement at a rate of 10 Hz, while other modules allow a sampling rate of up to 100 Hz.

Typical values of C/NO range from 20 dB-Hz to 45 dB-Hz, where in some embodiments a signal strength of 45 dB-Hz is indicative of the satellite being an LOS satellite with respect to the receiver, and any value below 25 dB-Hz indicates the satellite being an NLOS satellite with respect to the receiver. In some embodiments, any signal strength above 40 dB-Hz is considered to be indicative of an LOS satellite with high probability. The midrange (below 40 dB-Hz and above 25 dB-Hz) is typically not helpful in LOS/NLOS classification. However, for the purpose of lane detection, all satellites must be classified as LOS satellites or as NLOS satellites.

Experimental evidence shows that, in an open-sky scenario such as typically present along a highway, and under conditions where reception is not affected by the carrying object (e.g., using a suitable antenna, such as an external antenna mounted on the exterior of an object that is vehicle), no mid-range values are obtained, and thus all satellites can be unambiguously classified as LOS satellites or NLOS satellites. As seen in FIG. 7, many signal intensity values 700 measured as described hereinabove are above 40 dB-Hz, and are indicative of satellites being LOS with respect to the GNSS receiver. One of the measured signal intensity values 702 is below 25 dB-Hz, and is indicative of that satellite being NLOS with respect to the GNSS receiver. No signal intensity values are recorded in the midrange of 25-40 dB-Hz, as indicated by reference numeral 704.

Additionally, the fluctuation in the signal-intensities between signal intensity values 700, or while satellites are in LOS state, are very small, typically below 3 dB-Hz. Thus, in highway conditions as described above, all satellites can be classified as LOS satellites or as NLOS satellites with a high level of confidence.

FIG. 8 shows recorded C/NO values of a satellite, positioned at an elevation of 64 degrees with respect to the GNSS receiver, over time. The values were measured while walking along a shading wall using a typical GNSS receiver. As seen, LOS and NLOS states of the satellite are clearly distinguishable in the Figure. Both the shine (NLOS to LOS transition) and the decline (LOS to NLOS transition) of the satellite are very rapid.

The characteristics identified in FIG. 8 are the basic pre-condition for any shadow matching algorithm—the ability to identify with high certainty whether a satellite is LOS or NLOS. The problem, however, is that the ability to detect a narrow utility pole (approximately 20 cm in width) while driving at a speed of 90 kilometers/hour, or 25 meters/second, is almost impossible at a 10 Hz SNR sampling rate. Thus, in some embodiments, a sampling rate of at least 60 Hz, at least 80 Hz, or even at least 100 Hz is used for providing accurate lane detection at speeds typically used on highways.

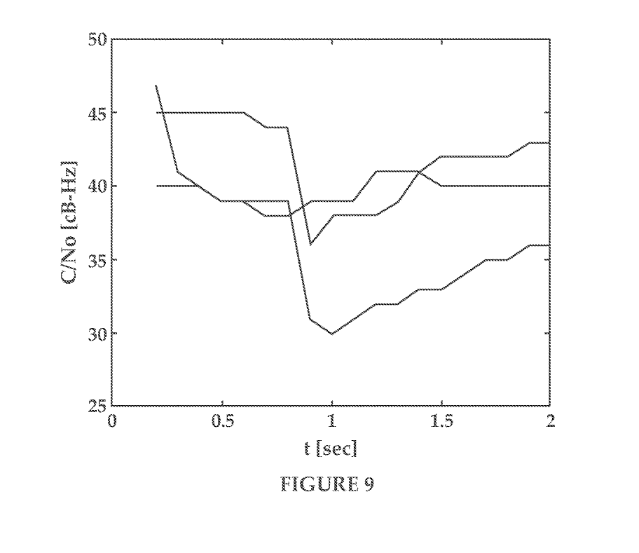

Reference is now made to FIG. 9, which is a graphic depiction of signal attenuation at 10 Hz from three different satellites according to an embodiment of the teachings herein. FIG. 9 shows a signal-strength recording while driving at 40 kmh. Rapid Signal Attenuation (RSAT) can easily be detected within 0.1 seconds. Signal intensification is typically not as rapid as signal attenuation, but this is often caused by smoothing algorithms operative in GNSS receivers. As seen in FIG. 5, all the RSAT values are at least 7-8 dB-Hz within 0.1 seconds, which is a magnitude of RSAT that can be detected in an open sky scenario such as the one shown in FIG. 3. Moreover, since typically highways and intersections present an open-sky scenario, the position estimation of a GNSS receiver is rather accurate (within 10-15 meters of the actual position) and can be used to seek RSATs caused by obstacles which correlate to, or can be found in or near, the estimated position.

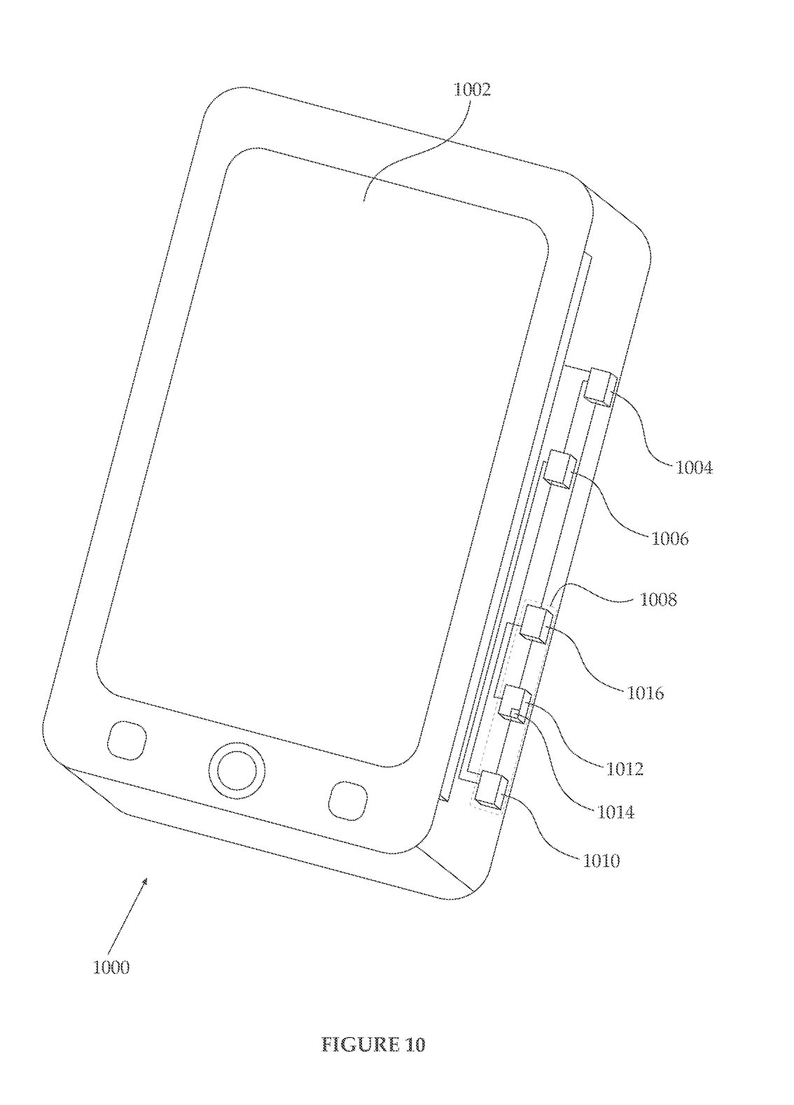

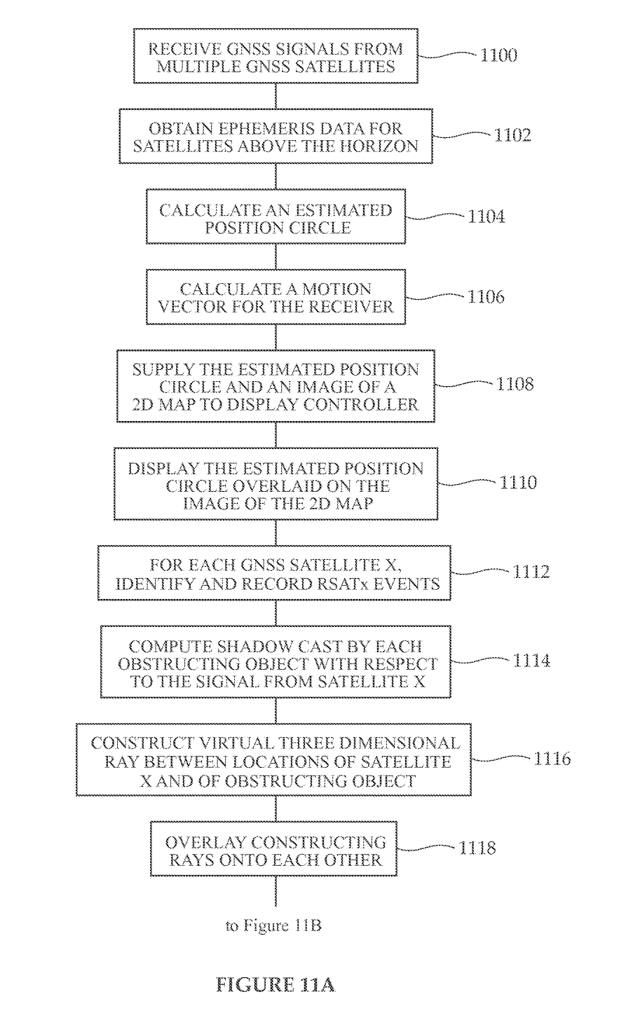

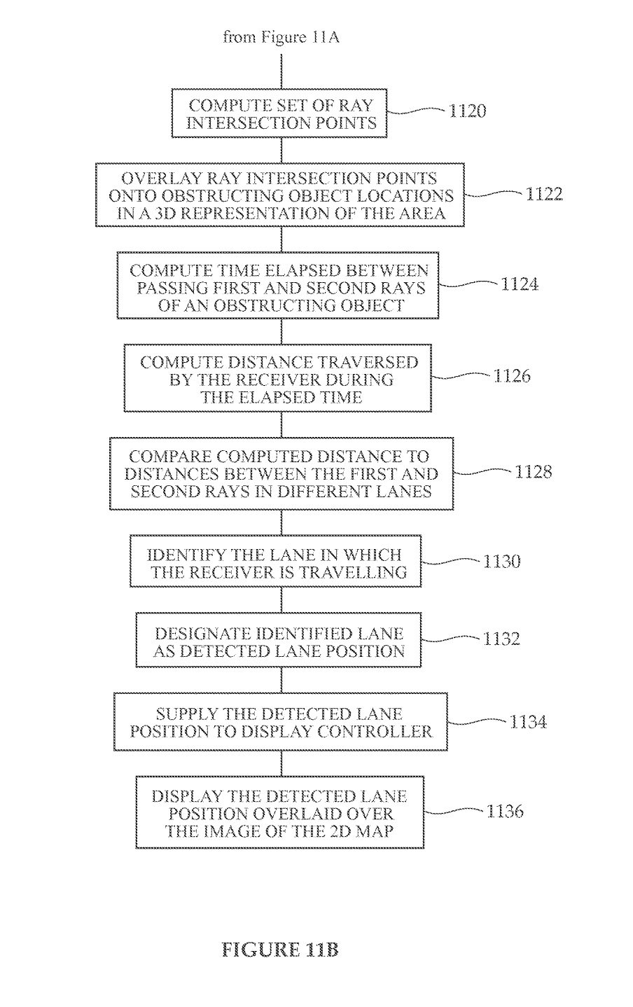

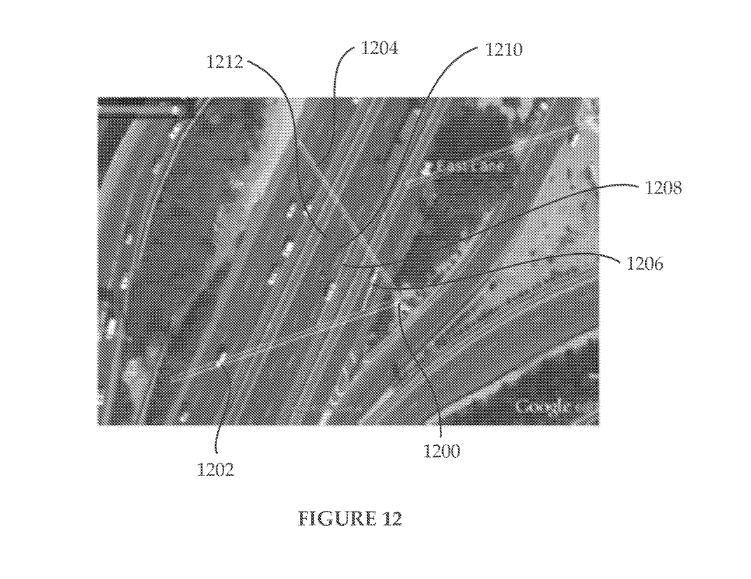

Reference is now made to FIG. 10, which is a schematic depiction of an embodiment of a GNSS receiver according to the teachings herein, suitable for implementing embodiments of car lane detection using GNSS signals according to an embodiment of the teachings herein, to FIG. 11, which is a flow chart of an embodiment of a method for accurate lane detection using GNSS satellite shadows according to an embodiment of the teachings herein, and to FIG. 12, which is a schematic depiction of a computation for lane detection using GNSS devices according to an embodiment of the teachings herein. Thus, according to an aspect of some embodiments of the invention there is also provided a method for determining the position of a GNSS receiver, comprising:

a) at a monitoring rate, monitoring at least two GNSS satellites that are located above the horizon with respect to a GNSS receiver to identify a Rapid Signal Attenuation (RSAT) event corresponding to the at least two GNSS satellites;
b) using a three dimensional representation of a presumed location area of the GNSS receiver representative of at least one obstructing object in the presumed location area, computing a shadow cast by the at least one obstructing object with respect to the signal from each of the at least two satellites;
c) measuring the a duration elapsed between the GNSS receiver passing a first shadow cast by the at least one obstructing object with respect to a signal from a first of the at least two GNSS satellites and a second shadow cast by the at least one obstructing object with respect to a signal from a second of the at least two GNSS satellites;
d) computing a distance traversed by the GNSS receiver during the measured duration; and
e) comparing the computed distance to distances identified in the three dimensional representation to thereby identify a lane in which the GNSS receiver is travelling.

According to an aspect of some embodiments of the invention there is also provided a device for determining the position of a GNSS receiver, comprising:
a) an RSAT monitoring module, configured to monitor at least two GNSS satellites that are located above the horizon with respect to a GNSS receiver to identify a Rapid Signal Attenuation (RSAT) event corresponding to the at least two GNSS satellites, at a monitoring rate;
b) a shadow identifying module, configured to use a three dimensional representation of a presumed location area of the GNSS receiver representative of at least one obstructing object in the presumed location area to compute a shadow cast by the at least one obstructing object with respect to the signal from each of the at least two satellites; and
c) a lane identifying module, configured to:
   i. measure a duration elapsed between the GNSS receiver passing a first shadow cast by the at least one obstructing object with respect to a signal from a first of the at least two GNSS satellites and a second shadow cast by at least one obstructing object with respect to a signal from a second of the at least two GNSS satellites;
   ii. compute a distance traversed by the GNSS receiver during the measured duration; and
   iii. compare the computed distance to distances identified in the three dimensional representation to thereby identify a lane in which the GNSS receiver is travelling.

Turning to FIG. 10, it is seen that a GNSS receiver 1000 according to an embodiment of the teachings herein includes a display screen 1002, a display controller 1004 and a prior art GNSS navigation module 1006, for example, such as on the Snapdragon S4 SoC by Qualcomm of San Diego, Calif., USA, functionally associated therewith. In the illustrated embodiment, the GNSS receiver 1000 comprises a modified smartphone, such as a Galaxy S III by Samsung of Seoul, South Korea. However, any other suitable GNSS receiver may be modified to include an implementation of the teachings herein. Specifically, in some embodiments, a GNSS receiver 1000 according to the teachings herein comprises a GNSS receiver mounted upon or within a vehicle, either manned or unmanned, which is modified to implement the teachings herein, e.g, includes hardware and/or software and/or firmware according to the teachings herein as described further hereinbelow.

Navigation module 1006 is configured to receive GNSS signals from a plurality of GNSS satellites located above the horizon with respect to GNSS receiver 1000, such as the American GPS satellites, as indicated by reference numeral 1100 in FIG. 11, and to obtain ephemeris data for all satellites located above the horizon with respect to receiver 1000, at reference numeral 1102 of FIG. 11. In some embodiments, the obtained ephemeris data includes a three dimensional position of each GNSS satellite. The ephemeris data can be obtained, for example, from a database located remotely from the GNSS receiver, or in any other suitable manner, as is well known in the art.

The navigation module 1006 calculates a presumed location area of receiver 1000 as an estimated position circle in the usual way, at reference numeral 1104 of FIG. 11. Due to the open sky scenario, which is typical to highways and intersections, the GNSS receiver 1000 typically has a line of sight to four or more GNSS satellites, and can thus estimates its own position, using methods known in the art, to a predetermined accuracy. In some embodiments, the GNSS receiver 1000 estimates its own position such that the estimated position is within 30 meters of the actual position of the GNSS receiver 1000.

Using methods known in the art and in the usual way, navigation module 1006 also calculates the motion vector (speed and direction of motion) of receiver 1000, at reference numeral 1106 of FIG. 11. Once again, due to the open sky scenario, the GNSS receiver can estimate its own velocity and direction to a predetermined accuracy. In some embodiments, the GNSS receiver 1000 estimates its own velocity such that the magnitude of the estimated velocity is within 1 kmh of the actual velocity, and such that the direction of the estimated velocity is within a two degree error of the direction of the actual velocity of receiver 1000.

In some embodiments, at reference numeral 1108 of FIG. 11, navigation module 1006 supplies the estimated position circle and an image of a portion of a stored 2D map that includes the estimated position circle to display controller 1004. Display controller 1004 displays the estimated position circle overlaid on an image of a 2D map on display screen 1002 at a display rate, typically 1 Hz, at reference numeral 1110 of FIG. 11, thus reporting the estimated position circle to a user of the GNSS receiver.

As seen in FIG. 10, GNSS receiver 1000 further includes a software component 1008, such as a program written in the usual way, which is configured to implement embodiments of the teachings herein. Software component 1008 includes a Rapid Signal ATtenuation (RSAT) monitor 1010 functionally associated with navigation module 1006. Software component 1008 further includes a ray constructor 1012 including a 3D representation 1014 of the area in which receiver 1000 is found, such as a city, and functionally associated with navigation module 1006 and with RSAT monitor 1010. In some embodiments, 3D representation 1014 includes an accurate three dimensional model of utility poles and other obstructing objects preset in the area in which receiver 1000 is found. As discussed above, the 3D representation 1014 can be obtained from any suitable source, including, for example, a remote database, or computation within the GNSS receiver 1000. A lane detection module 1016 is functionally associated with RSAT monitor 1010, ray constructor 1012 and with display controller 1104.

RSAT monitor 1010 is configured to monitor all GNSS satellites that are located above the horizon with respect to receiver 1000 to identify and record RSAT events, which represent rapid signal attenuation for a signal received by navigation module 1006 from a specific satellite X, at reference numeral 1112 of FIG. 11. Such a rapid signal attenuation event with respect to satellite X is denoted RSATx, and is indicative of the receiver 1000 passing through a shadow of an obstructing object with respect to satellite X.

In some embodiments, RSAT monitor 1010 monitors the satellites for a RSAT event at a monitoring rate, for example a monitoring rate of at least 60 Hz, at least 80 Hz, or even at least 100 Hz. In some embodiments, an RSAT event relative to a given satellite is identified by a drop in received signal intensity from an intensity of at least 40 dB-Hz to an intensity lower than 25 dB-Hz in a duration of less than 100 ms, less than 10 ms, or even less than 1 ms. In some embodiments, the duration in which the signal intensity drops is dependent on the width of the obstacle and on the velocity of receiver 1000. In some embodiments, at each RSAT point, RSAT monitor computes whether or not there is a line of sight between receiver 1000 and GNSS satellite X.

Ray constructor 1012 is configured to use ephemeris data for each satellite X located above the horizon with respect to receiver 1000, as well as the 3D representation of the obstructing objects, to compute the shadow cast by each obstructing object with respect to the signal from satellite X, at reference numeral 1114 of FIG. 11. Based on the computed shadows, for each RSATx event reported by RSAT monitor 1010, ray constructor 1012 constructs a virtual three dimensional ray between the known position of satellite X and an estimated location at which the RSATx event occurred, at reference numeral 1116 of FIG. 11.

Ray constructor 1012 proceeds to overlay a set of rays corresponding to the tracked RSAT events for all satellites X onto each other, at reference numeral 1118 of FIG. 11. As a result, a set of ray intersection points is computed at reference numeral 1120, which ray intersection points correspond to locations of obstructing objects and are the typically the origins of the rays, similar to the ray intersections illustrated in FIG. 6. At reference numeral 1122, the ray constructor 1012 overlays the set of rays and ray intersection points onto the 3D representation 1014 such that ray intersection points correspond to locations of obstructing objects, such as utility poles, modeled in the 3D representation.

Reference is now made to FIG. 12, in which it is seen that an obstructing object 1200 defines two shadow rays 1202 and 1204 with respect to two satellites S1 and S2 (not shown). As seen by line segments 1206, 1208, 1210, and 1212, the distance traversed by a vehicle after crossing shadow ray 1202 until crossing shadow ray 1204 is dependent on the depth of the angle at which the vehicle is travelling with respect to obstructing object 1200, or, stated differently on the distance of the lane in which the vehicle is travelling from obstructing object 1200. The farther the lane in which the vehicle is travelling is from the obstructing object 1200, the greater the distance traversed between crossing shadow rays 1202 and 1204, as is evident from comparison of the lengths of line segment 1206, in which the vehicle is travelling in the lane closest to obstructing object 1200, and line segment 1212, in which the vehicle is travelling in the lane farthest from obstructing object 1212. This characteristic of the distances traversed by a vehicle crossing two shadow rays such as rays 1202 and 1204 is key to lane detection according to some embodiments of the teachings herein, as described hereinbelow.

Returning to FIGS. 10 and 11, it is seen that ray constructor 1012 supplies the updated 3D representation 1014 including the ray intersection points to lane detection module 1016 at a data transfer rate. Lane detection module 1016 also receives the RSATx records, and specifically the RSATx timestamps, from RSAT monitor 1010. At reference numeral 1224 of FIG. 11, lane detection module 1016 computes the time that elapsed between the receiver 1000 passing a first ray defined by an obstructing object and a first GNSS satellite, and the receiver 1000 passing a second ray defined by the same obstructing object and a second GNSS satellite, different from the first GNSS satellite, as indicated by the timestamps of two different RSAT events relating to the same obstructing object.

Given the velocity of receiver 1000 as computed by navigation module 1006, lane detection module 1016 computes the distance traversed by receiver 1000 while travelling between the first ray and the second ray using the formula distance equals velocity over time, as seen at reference numeral 1126 of FIG. 11. Lane detection module 1016 then compares the computed distance to the distances between the first and second rays at different lanes using 3D representation 1014 received from ray constructor 1012 at reference numeral 1128 of FIG. 11, and at reference numeral 1130 concludes that the receiver 1000 is located in the lane for which the distance between the first and second rays is the closest to the computed distance traversed by the receiver 1000. The detected lane is designated as the detected lane position at reference numeral 1132 of FIG. 11.

Lane detection module 1016 is configured to supply the detected lane position to display controller 1004 for display to a user of GNSS receiver 1000 on display screen 1002. Specifically, during use of navigation module 1006, navigation module 1006 calculates the estimated position circle and display controller 1004 displays the estimated position circle overlaid on an image of a 2D map on display screen 1002 at a display rate, typically 1 Hz.

When software component 1008 is activated to implement the teachings herein, lane detection module 1016 supplies display controller 1004 with the detected lane position at the display rate, as seen at reference numeral 1134 of FIG. 11. Display controller 1004 then displays estimated position circle overlaid on an image of a 2D map as usual, but with the detected lane position marked differentially, for example in a different color or using different shading, at reference numeral 1136 of FIG. 11.

In the embodiment described above, the lane in which the receiver is travelling calculated in accordance with the teachings herein and designated as the detected lane position, is displayed to a user of receiver 1000 on display screen 1002 together with a presumed location area, such as the estimated position circle computed by navigation module 1006. In some embodiments, the lane in which the receiver is travelling calculated in accordance with the teachings herein is displayed on a display screen, without a presumed location area. In some embodiments, lane in which the receiver is travelling calculated in accordance with the teachings herein is used as input for an improved subsequent calculation of a presumed location area, for example, used as input for a dead-reckoning system and/or an inertial navigation system.

In some embodiments, in which there is no human user viewing display screen 1002 of receiver 1000, such as when receiver 1000 is installed in an unmanned automobile, the lane in which the receiver is travelling calculated in accordance with the teachings herein and designated as the detected lane position is not displayed on display screen 1002. In some such embodiments, the detected lane position is communicated to a controller of the unmanned vehicle, such as via a wireless communication network or any suitable communication method.

Generally, the greater the number of RSATs used, the greater the accuracy of lane detection that can be achieved.

It is important to note that for many practical GNSS navigation implementations, lane detection is of exceptional utility on intersecting lanes or on forking lanes, and specifically on differentiating between lanes that lead to different destinations. This kind of scenario is demonstrated in FIG. 12, where the lane closest to the obstructing object 1200 must be distinguishable from the other lanes as it leads to a different destination. It is appreciated that in the simplified scenario of FIG. 12, a single pole and two satellites enable unique identification of the lane closest to obstructing object 1200, and distinction thereof from other lanes. That said, given enough poles and satellites, for example ten LOS satellites and a sufficient number of mapped poles, the teachings herein allow a greater number of lanes to be uniquely identified using embodiments of the methods of the teachings herein.

It is appreciated that monitoring of RSAT events as described hereinabove can be used to improve the accuracy of position determination in any environment having many narrow obstructing objects, such as along roads, even when not attempting to detect a lane in which a receiver is travelling.

It is appreciated that certain features of the invention, which are, for clarity, described in the context of separate embodiments, may also be provided in combination in a single embodiment. Conversely, various features of the invention, which are, for brevity, described in the context of a single embodiment, may also be provided separately or in any suitable subcombination or as suitable in any other described embodiment of the invention. Certain features described in the context of various embodiments are not to be considered essential features of those embodiments, unless the embodiment is inoperative without those elements.

Although the invention has been described in conjunction with specific embodiments thereof, it is evident that many alternatives, modifications and variations will be apparent to those skilled in the art. Accordingly, it is intended to embrace all such alternatives, modifications and variations that fall within the scope of the appended claims.

Citation or identification of any reference in this application shall not be construed as an admission that such reference is available as prior art to the invention.

Section headings are used herein to ease understanding of the specification and should not be construed as necessarily limiting.

1. A method for determining the position of a GNSS receiver, comprising:
a) from a GNSS receiver, at a monitoring rate, monitoring at least one GNSS satellite that is located above said horizon with respect to said GNSS receiver to identify a transition event where said GNSS receiver changes from:
i. LOS to NLOS—having an unobstructed line of sight to at least one specific satellite of said at least one GNSS satellite to not having an unobstructed line of sight to said at least one specific satellite; or
ii. NLOS to LOS—not having an unobstructed line of sight to at least one specific satellite of said at least one GNSS satellite to having an unobstructed line of sight to said at least one specific satellite;
b) if a transition event is identified, identifying a portion of a presumed location area of said GNSS receiver that corresponds to a border of a shadow cast by an object that accounts for said transition event.

2. The method of claim 1, wherein said transition event is identified by a change in signal intensity received by said GNSS receiver from a satellite.

3. The method of claim 2, wherein said transition event where said GNSS receiver changes from (i) LOS to NLOS is identified by a reduction in said signal intensity received from said satellite.

4. The method of claim 2, wherein said transition event where said GNSS receiver changes from (ii) NLOS to LOS is identified by an increase in said signal intensity received from said satellite.

5. The method of claim 1, wherein said transition event is identified by a change in direction of Doppler shift of a signal received by said GNSS receiver from said at least one GNSS satellite.

6-9. (canceled)

10. The method of claim 1, wherein said monitoring also comprises assigning a timestamp to said transition event, and wherein said identifying said portion comprises identifying said border only if said timestamp assigned to said transition event is not older than a predetermined threshold duration.

11. (canceled)

12. The method of claim 1, also comprising combining said identified portions for each of said at least one GNSS satellite for which a transition event was identified, to obtain an identified receiver position.

13-15. (canceled)

16. A device for calculating the position of a GNSS receiver, comprising:
a) a transition monitoring module, configured to, at a monitoring rate, monitor signal characteristics received by a GNSS receiver from a GNSS satellite that is located above said horizon with respect to said GNSS receiver, and to identify a transition event where said signal characteristics indicate that said GNSS receiver changes from:
i. LOS to NLOS—having an unobstructed line of sight to said GNSS satellite to not having an unobstructed line of sight to said GNSS satellite; or
ii. NLOS to LOS—not having an unobstructed line of sight to said to said GNSS satellite to having an unobstructed line of sight to said GNSS satellite; and
b) a location improver, configured to, upon said identification of a transition event:
i. obtain a presumed location area of said GNSS receiver;
ii. determine a portion of said presumed location area that corresponds to a border of a shadow cast by an object that accounts for said identified transition event; and
iii. report said portion of said presumed location.

17. The device of claim 16, wherein said signal characteristics indicating a transition event comprise a change in signal intensity received by said GNSS receiver from said GNSS satellite.

18. The device of claim 17, wherein said transition event where said GNSS receiver changes from (i) LOS to NLOS is identified by a reduction in said signal intensity received from said GNSS satellite.

19. The device of claim 17, wherein said transition event where said GNSS receiver changes from (ii) NLOS to LOS is identified by an increase in said signal intensity received from said GNSS satellite.

20. The device of claim 16, wherein said signal characteristics indicating a transition event comprise a change in direction of Doppler shift of a signal received by said GNSS receiver from said GNSS satellite.

21-23. (canceled)

24. The device of claim 16, wherein said transition monitoring module is also configured to assign a timestamp to said transition event, and said location improver is configured to identify said portion corresponding to said border only if said timestamp assigned to said transition event is not older than a predetermined threshold duration.

25-30. (canceled)

31. A method for determining the position of a GNSS receiver, comprising:
a) at a monitoring rate, monitoring at least two GNSS satellites that are located above said horizon with respect to a GNSS receiver to identify a Rapid Signal Attenuation (RSAT) event corresponding to said at least two GNSS satellites;
b) using a three dimensional representation of a presumed location area of said GNSS receiver representative of at least one obstructing object in said presumed location area, computing a shadow cast by said at least one obstructing object with respect to said signal from each of said at least two satellites;
c) measuring said a duration elapsed between said GNSS receiver passing a first shadow cast by said at least one obstructing object with respect to a signal from a first of said at least two GNSS satellites and a second shadow cast by said at least one obstructing object with respect to a signal from a second of said at least two GNSS satellites;
d) computing a distance traversed by said GNSS receiver during said measured duration; and
e) comparing said computed distance to distances identified in said three dimensional representation thereby to identify a lane in which said GNSS receiver is travelling.

32. The method of claim 31, also comprising computing at least one of said presumed location area of said GNSS receiver at a presumed area computing rate and a motion vector of said GNSS receiver at a motion vector computing rate.

33. The method of claim 31, also comprising obtaining ephemeris data for GNSS satellites located above said horizon with respect to said GNSS receiver.

34. The method of claim 31, also comprising displaying said presumed location area at a display rate.

35. The method of claim 31, wherein said monitoring comprises identifying a said RSAT event by identifying a drop in intensity of a signal received from a corresponding one of said at least two GNSS satellites from an intensity of at least 40 dB-Hz to an intensity lower than 25 dB-Hz.

36. The method of claim 31, also comprising, following said computing said shadows, for each RSAT event, constructing a virtual three dimensional ray between a known position of a satellite corresponding to said RSAT event and an estimated location at which said RSAT event occurred.

37. The method of claim 36, also comprising overlaying said virtual three dimensional rays constructed for different RSAT events over one another and over said three dimensional representation, such that intersections of said virtual three dimensional rays correspond to locations of obstructing objects in said three dimensional representation.

38. The method of claim 31, wherein said computing said distance comprises computing said distance based on said measured duration and on a motion vector of said GNSS receiver.

39. The method of claim 31, wherein said comparing said computed distance comprises comparing said computed distance to distances between said first shadow and said second shadow in each of multiple lanes represented in said three dimensional representation.

40-42. (canceled)

43. A device for determining the position of a GNSS receiver, comprising:
a) an RSAT monitoring module, configured to monitor at least two GNSS satellites that are located above said horizon with respect to a GNSS receiver to identify a Rapid Signal Attenuation (RSAT) event corresponding to said at least two GNSS satellites, at a monitoring rate;
b) a shadow identifying module, configured to use a three dimensional representation of a presumed location area of said GNSS receiver representative of at least one obstructing object in said presumed location area to compute a shadow cast by said at least one obstructing object with respect to said signal from each of said at least two satellites; and
c) a lane identifying module, configured to:
i. measure a duration elapsed between said GNSS receiver passing a first shadow cast by said at least one obstructing object with respect to a signal from a first of said at least two GNSS satellites and a second shadow cast by said at least one obstructing object with respect to a signal from a second of said at least two GNSS satellites;
ii. compute a distance traversed by said GNSS receiver during said measured duration; and
iii. compare said computed distance to distances identified in said three dimensional representation thereby to identify a lane in which said GNSS receiver is travelling.

44. The device of claim 43, also comprising a navigation module configured to compute at least one of said presumed location area of said GNSS receiver at a presumed area computing rate and a motion vector of said GNSS receiver.

45. The device of claim 43, wherein said navigation module is also configured to obtain ephemeris data for GNSS satellites located above said horizon with respect to said GNSS receiver.

46. The device of claim 43, also comprising a display screen configured to display said presumed location area at a display rate.

47. The device of claim 43, wherein said three dimensional representation includes a three dimensional model of utility poles and other obstructing objects preset in said presumed location area.

48. The device of claim 43, wherein said RSAT monitoring module is configured to identify a said RSAT event by identifying a drop in an intensity of a signal received from a corresponding one of said at least two GNSS satellites from an intensity of at least 40 dB-Hz to an intensity lower than 25 dB-Hz.

49. The device of claim 43, wherein said shadow identifying module is configured to construct, for each said RSAT event, a virtual three dimensional ray between a known position of a satellite corresponding to said RSAT event and an estimated location at which said RSAT event occurred.

50. The device of claim 49, wherein said shadow identifying module is also configured to overlay said virtual three dimensional rays constructed for different RSAT events over one another and over said three dimensional representation, such that intersections of said virtual three dimensional rays correspond to locations of obstructing objects in said three dimensional representation.

51. The device of claim 43, wherein said lane identifying module is configured to compute said distance based on said measured duration and on a motion vector of said GNSS receiver.

52. The device of claim 43, wherein said lane identifying module is configured to compare said computed distance to distances between said first shadow and said second shadow in each of multiple lanes represented in said three dimensional representation.

53-55. (canceled)
